(19) United States
(12) Patent Application Publication
(10) Pub. No.: US 2015/0213218 A1
(43) Pub. Date: Jul. 30, 2015

(54) MEDICAL INFORMATION MANAGEMENT APPARATUS

(71) Applicants: Kabushiki Kaisha Toshiba, Minato-ku (JP); Toshiba Medical Systems Corporation, Otawara-shi (JP)

(72) Inventors: Shigeyuki ISHII, Nasushiobara (JP); Satoshi Ikeda, Yaita (JP)

(73) Assignees: Kabushiki Kaisha Toshiba, Minato-ku (JP); Toshiba Medical Systems Corporation, Otawara-shi (JP)

(21) Appl. No.: 14/678,623

(22) Filed: Apr. 3, 2015

Related U.S. Application Data
(63) Continuation of application No. PCT/JP2013/082015, filed on Nov. 28, 2013.

(30) Foreign Application Priority Data
Nov. 28, 2012 (JP) 2012-259596

(51) Int. Cl. G06F 19/00

(52) U.S. Cl. CPC G06F 19/3425; G06F 19/322

(57) ABSTRACT

A medical information management apparatus according to an embodiment is communicably connected to a plurality of client terminals. The medical information management apparatus includes a reference information storage device, a recommended information acquisition device, and a providing device. The reference information storage device stores reference information for medical information referred to by a participant in a past medical meeting. The recommended information acquisition device acquires recommended medical information from medical information of a target patient in a current medical meeting based on the reference information. The providing device provides the acquired recommended medical information to each of the client terminals.

### CROSS-REFERENCE TO RELATED APPLICATIONS

This application is a Continuation application of PCT application No. PCT/JP2013/082015, filed on Nov. 28, 2013, and is based upon and claims the benefit of priority from Japanese Patent Application No. 2012-259596, filed on Nov. 28, 2012, the entire contents of which are incorporated herein by reference.

### FIELD

Embodiments described herein relate generally to a medical information management apparatus.

### BACKGROUND

Recently, in order to implement patient-centered medical care, many hospitals have introduced team medical care.

Team medical care is medical care aimed at further enhancing the satisfaction of a given patient by letting the given patient himself/herself participate as a member of a team in medical care and making members of all kinds of professions involved in the medical care exert their respective expertise.

Note that the professions associated with team medical care include various types of professions such as doctor, nurse, pharmacist, and nutritionist. In addition, team medical care involves not only a team who directly provides medical care but also a team who supports a patient and his/her family, including welfare experts, mental care experts, and spiritual care experts and a team constituted by social resources associated with medical care and the patient, including the family, friends, companies, mass media, and government.

To perform medical care based on an instruction system headed by a doctor has been the mainstream. In contrast to this, in team medical care, the members of the respective professions work in equal partnership. In addition, in team medical care, discussions are held with a patient based on the expert opinions of the members of the respective professions, and the members perform medical care in cooperation with each other based on the obtained consensus of the team. The actions of the members of the respective professions need to hold responsibility as a team. In addition, in team medical care, the members of the respective professions are required to provide leadership and mutually respect each other, depending on the situation.

In the above team medical care, a so-called MDT (Multidisciplinary Team) meeting is held. Note that MDT is synonymous with team medical care, and an MDT meeting is a means for implementing “patient-centered medical care” as an object of MDT.

In a periodically held MDT meeting, participants who are in charge of the respective professions (to be written as MDT members hereinafter) hold discussions about a treatment policy for a patient and the like, and reach conclusions by making the most of their own expertise. Note that an MDT meeting is performed by using a conference system such as a system using a large screen or a video conference system between remote places.

For a discussion in an MDT meeting, information concerning a patient is required. Since MDT members differ in expertise, information required for the MDT meeting greatly varies. For this reason, a wide variety of information is sometimes displayed on the terminal used by each MDT member. Alternatively, such information is sometimes displayed on the large screen of a terminal.

In addition, the time that can be spent for an MDT meeting is limited, and hence conclusions are often reached in several minutes per patient brought up for discussion.

It is therefore important to quickly display (or switch) information about a patient in an MDT meeting.

It is an object to provide a medical information management apparatus which can quickly display patient information required for a discussion on a terminal.

### BRIEF DESCRIPTION OF THE DRAWINGS

FIG. 1 is a block diagram mainly showing the functional arrangement of a medical information management system according to the first embodiment.

FIG. 2 is a view showing an example of the data structure of login information stored in a storage unit 21 shown in FIG. 1.

FIG. 3 is a view showing an example of the data structure of information referred history information stored in the storage unit 21 shown in FIG. 1.

FIG. 4 is a flowchart showing a processing procedure in the medical information management system according to this embodiment.

FIG. 5 is a view for explaining reference information acquired by an information referred history acquisition unit 23.

FIG. 6 is a view for explaining a case in which the reference information shown in FIG. 5 is converted by an information referred history conversion unit 24.

FIG. 7 is a view for explaining display screens when medical information is displayed on a client terminal 20.

FIG. 8 is a view showing an example of the data structure of information referred history information stored in a storage unit 21 according to the second embodiment.

FIG. 9 is a view showing an example of a display screen on a client terminal 10 when medical information is displayed by an information display unit 12.

FIG. 10 is a block diagram mainly showing the functional arrangement of a medical information management system according to the third embodiment.

FIG. 11 is a flowchart showing a processing procedure in the medical information management system according to this embodiment.

FIG. 12 is a view showing an example of a display screen on a client terminal 100 when medical information is displayed by an information display unit 12.

FIG. 13 is a block diagram mainly showing the functional arrangement of a medical information management system according to the fourth embodiment.

FIG. 14 is a flowchart showing a processing procedure for information referred history update processing executed by the medical information management system according to this embodiment.

FIG. 15 is a block diagram mainly showing the functional arrangement of a medical information management system according to the fifth embodiment.

FIG. 16 is a view showing an example of the data structure of role-related information stored in a storage unit 221 shown in FIG. 15.

FIG. 17 is a flowchart showing a processing procedure in the medical information management system according to this embodiment.

FIG. 18 is a view for explaining related information acquired by a related information narrowing down unit 222.

FIG. 19 is a view for explaining the result obtained by the related information narrowing down unit 222 by narrowing down post-conversion reference information.

FIG. 20 is a block diagram mainly showing the functional arrangement of a medical information management system according to the sixth embodiment.

FIG. 21 is a flowchart showing a processing procedure of processing for participant terminals which is executed by the medical information management system according to this embodiment.

FIG. 22 is a view showing an example of the data structure of patient history information stored in a storage unit 21 according to the seventh embodiment.

FIG. 23 is a flowchart showing a processing procedure in the medical information management system according to this embodiment.

FIG. 24 is a block diagram mainly showing the functional arrangement of a medical information management system according to the eighth embodiment.

FIG. 25 is a view showing an example of the data structure of difference management information stored in a storage unit 241 shown in FIG. 24.

FIG. 26 is a flowchart showing a processing procedure in the medical information management system according to this embodiment.

FIG. 27 is a view for explaining an image having undergone difference enhancement processing.

FIG. 28 is a block diagram mainly showing the functional arrangement of a medical information management system according to the ninth embodiment.

FIG. 29 is a view showing an example of the data structure of category-specific related information stored in a storage unit 251 shown in FIG. 28.

FIG. 30 is a flowchart showing a processing procedure in the medical information management system according to this embodiment.

FIG. 31 is a view for explaining a display screen according to a modification of the sixth embodiment.

FIG. 32 is a view for explaining a display screen according to another modification of the sixth embodiment.

### DETAILED DESCRIPTION

In general, according to an embodiment, a medical information management apparatus is communicably connected to a plurality of client terminals.

The medical information management apparatus includes a reference information storage device, a recommended information acquisition device, and a providing device.

The reference information storage device is configured to store reference information of medical information referred to by participants in a past medical meeting.

The recommended information acquisition device is configured to acquire recommended medical information from medical information about a target patient in the current medical meeting based on the reference information.

The providing device is configured to provide the acquired recommended medical information for each of the client terminals.

Each embodiment will be described below with reference to the accompanying drawings.

### First Embodiment

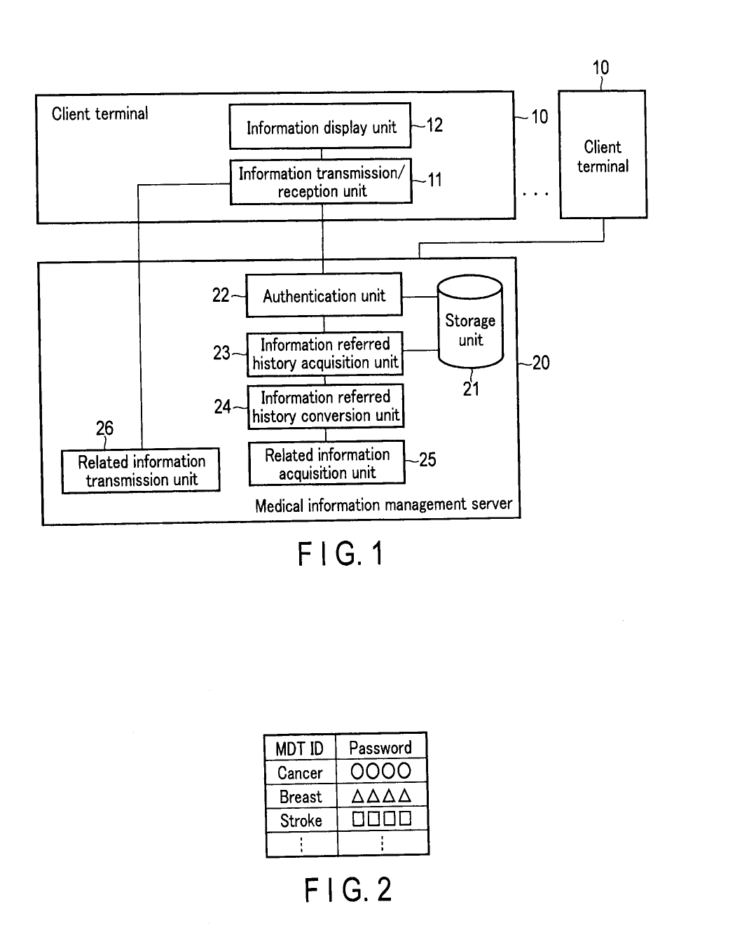

FIG. 1 is a block diagram mainly showing the functional arrangement of a medical information management system according to the first embodiment. The medical information management system according to this embodiment is used when, for example, a medical team constituted by participants of a plurality of professions holds a meeting (MDT meeting) for discussions about a treatment policy and the like for a patient in team medical care (MDT: Multidisciplinary Team) for providing medical treatment for the patient.

As shown in FIG. 1, the medical information management system includes a medical information management server (medical information management apparatus) 20 communicably connected to a plurality of client terminals 10. Note however that the medical information management server 20 is not limited to the configuration in which it is communicably connected to the plurality of client terminals 10, and it may be configured to be communicably connected to at least one client terminal 10.

In addition, although not shown, the medical information management server 20 is communicably connected via a network to various types of external systems such as a PACS (Picture Archiving and Communication Systems), HIS (Hospital Information System), RIS (Radiology Information System), and nurse record system. Assume that various types of medical information (image data, medication records, nurse records, and the like) are respectively saved in these external systems according to predetermined rules. In addition, the medical information management server 20 may include a medical information storage device configured to acquire and store medical information about a target patient from external systems (other apparatuses) via a network.

The respective client terminals 10 have the same hardware configuration, and hence one client terminal 10 will be described as a representative.

The client terminal 10 includes an information transmission/reception unit 11 and an information display unit 12. The information transmission/reception unit 11 is a functional unit for transmitting and receiving various types of information to and from the medical information management server 20.

More specifically, the information transmission/reception unit 11 transmits, to the medical information management server 20, type information (to be written as an MDT ID hereinafter) representing the type of medical team who holds a meeting and a password for logging in to the medical information management system. Note that the types of medical teams are classified according to diseases and purposes for which the medical teams provide team medical care, and include, for example, a team on cancer, a team on strokes, and a team on nutritional support.

In addition, the information transmission/reception unit 11 receives medical information about a patient under discussion in a meeting from the medical information management server 20, as will be described later. The medical information received by the information transmission/reception unit 11 includes image data, other data, and the like stored in the above external systems such as the picture archiving and communication system, hospital information system, radiology information system, and nurse record system.

The information display unit 12 is a functional unit for displaying various types of information. More specifically, the information display unit 12 displays the medical information received by the information transmission/reception unit 11 to the participants constituting the medical team.

The medical information management server 20 includes a storage unit 21, an authentication unit 22, an information referred history acquisition unit 23, an information referred history conversion unit 24, a related information acquisition unit 25, and a related information transmission unit 26.

The storage unit 21 stores login information and information referred history information in advance. The login information is information to be used when the medical team who holds the above meeting (the host of the meeting) logs in to the medical information management system. The information referred history information is information representing the history of medical information referred to by the medical team in past meetings. More specifically, information referred history information includes each method (reference information) of referring to medical information about a patient which was referred to in a past meeting in association with type information (MDT ID) representing the type of medical team who held the meeting. The storage unit 21 forms a reference information storage device configured to store the reference information of medical information referred to by participants in past meetings. The storage unit 21 may store the reference information of medical information referred to by a plurality of client terminals 10 during a medical meeting. In addition, reference information includes, for example, the identification information of referred medical information and may be stored in the storage unit 21 such that the identification information of a medical meeting is associated with the identification information of each participant in the medical meeting.

Note that login information and information referred history information will be described in detail later.

The authentication unit 22 receives the MDT ID and password transmitted by the information transmission/reception unit 11 included in the client terminal 10. The authentication unit 22 performs authentication based on the received MDT ID and password and the login information stored in the storage unit 21.

The information referred history acquisition unit 23 refers to the information referred history information stored in the storage unit 21, and acquires reference information (reference information for referring to medical information) contained in the information referred history information in association with the MDT ID received by the authentication unit 22.

The information referred history conversion unit 24 acquires patient identification information (to be written as a patient ID hereinafter) for identifying a patient under discussion in a meeting held by the type of medical team indicated by the MDT ID received by the authentication unit 22. The information referred history conversion unit 24 converts the reference information acquired by the information referred history acquisition unit 23 based on the patient ID received by the authentication unit 22.

The related information acquisition unit 25 acquires medical information from an external system based on the reference information converted by the information referred history conversion unit 24. The medical information acquired by the related information acquisition unit 25 is medical information corresponding to medical information which can be referred to by using the reference information acquired by the information referred history acquisition unit 23 (that is, medical information of the same type as that of medical information which can be referred to by using the reference information), and is medical information about the patient under discussion in the meeting. The information referred history acquisition unit 23, the information referred history conversion unit 24, and the related information acquisition unit 25 constitute a recommended information acquisition device configured to acquire recommended medical information among the medical information about the target patient in the current medical meeting based on the reference information stored in the reference information storage device. In addition, the information referred history acquisition unit 23, the information referred history conversion unit 24, and the related information acquisition unit 25 correspond to a recommended information acquisition device to be used when acquiring the type of recommended medical information based on the reference information of medical information referred to in a similar type of meeting held in the past, and acquiring recommended medical information in accordance with the acquired type. In addition, the related information acquisition unit 25 corresponds to a recommended information acquisition device to be used when acquiring medical information about a target patient from another apparatus via a network.

The related information transmission unit 26 transmits the medical information acquired by the related information acquisition unit 25 to the client terminal 10. The information transmission/reception unit 11 included in the client terminal 10 receives the medical information transmitted by the related information transmission unit 26. The information display unit 12 included in the client terminal 10 then displays the received information. The related information transmission unit 26 forms a providing device configured to provide the recommended medical information acquired by the recommended information acquisition device to each client terminal. In addition, the related information acquisition unit 25 may change the recommended medical information acquired by the related information acquisition unit 25 in accordance with role information about the owner of the client terminal 10, and provide the changed recommended medical information to the client terminal 10. Furthermore, the related information transmission unit 26 may provide medical information generated in and after a previous medical meeting concerning a target patient, as identifiable data, to the client terminal 10. For example, medical information and identification data for identifying the medical information as new data may be provided to the client terminal 10.

FIG. 2 shows an example of the data structure of login information stored in the storage unit 21 shown in FIG. 1.

As shown in FIG. 2, login information contains MDT IDs and passwords in association with each other. The MDT IDs represent the types of medical teams which hold meetings for discussion about a patient. The passwords are those determined in advance with respect to the types of medical teams indicated by the associated MDT IDs.

In the example shown in FIG. 2, the login information contains MDT ID “Cancer” and password “∘∘∘∘” in association with each other. This indicates that the type of medical team indicated by MDT ID “Cancer” can log in with password “∘∘∘∘”. Note that MDT ID “Cancer” indicates the type of medical team on cancer.

Although a detailed description will be omitted, login information defines passwords with respect to other MDT IDs in the same manner.

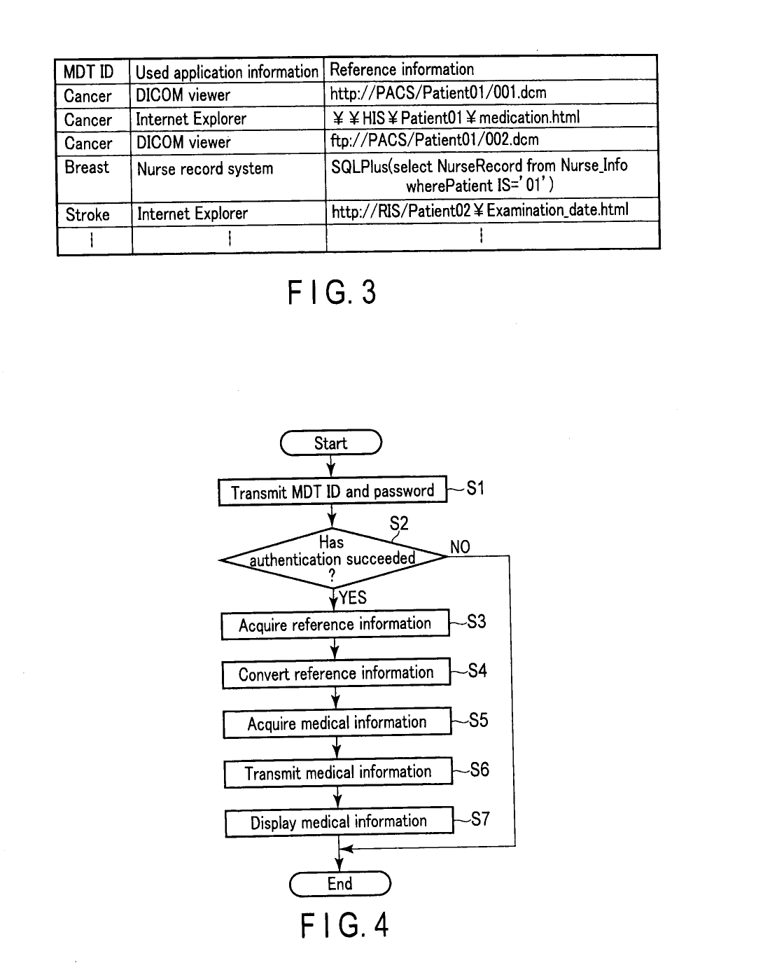

FIG. 3 shows an example of the data structure of the information referred history information stored in the storage unit 21 shown in FIG. 1.

As shown in FIG. 3, the information referred history information contains used application information and reference information (reference methods) in association with MDT IDs. An MDT ID indicates the type of medical team, as described above. Used application information indicates the application actually used when the type of medical team indicated by the associated MDT ID referred to medical information in a past meeting. Reference information is information for referring to medical information referred to by the type of medical team indicated by the associated MDT ID in a past meeting (that is, information for accessing the medical information). More specifically, this information contains a URI (Uniform Resource Identifier) indicating the storage position of the medical information (that is, the acquisition destination of the medical information) in an external system storing the medical information.

In the example shown in FIG. 3, the information referred history information contains used application “DICOM viewer” and reference information “http://PACS/patient01/001.dcm” in association with MDT ID “Cancer”. This information indicates that the type of medical team indicated by MDT ID “Cancer” (the medical team on cancer) referred to medical information accessible by using the DICOM viewer based on “http://PACS/patient01/001.dcm” in a past meeting.

As described above, information referred history information indicates the log of medical information referred to in a past meeting.

A processing procedure in the medical information management system according to this embodiment will be described next with reference to the flowchart of FIG. 4.

First of all, when using the medical information management system in a meeting for discussing about a patient, for example, the host of the meeting (each participant constituting the medical team who holds the meeting) needs to log in to the medical information management system.

In this case, the host of the meeting inputs an MDT ID indicating the type of medical team who holds the meeting and a password by operating the client terminal 10 when, for example, starting the meeting.

Note that a patient to be discussed in a meeting held by a medical team will be referred to as a target patient. This applies to the other embodiments to be described below.

When the host of the meeting inputs an MDT ID and a password in this manner, the information transmission/reception unit 11 included in the client terminal 10 transmits the input MDT ID and password to the medical information management server 20 (step S1).

The authentication unit 22 included in the medical information management server 20 receives the MDT ID and password transmitted by the client terminal 10 (the information transmission/reception unit 11 included in it).

The authentication unit 22 executes authentication processing based on the received MDT ID and password and the login information stored in the storage unit 21, and determines whether the authentication has succeeded or failed (step S2). If the received MDT ID and password are associated with the login information, the authentication unit 22 determines that the authentication has succeeded. In contrast to this, if the received MDT ID and password are not associated with the login information, the authentication unit 22 determines that the authentication has failed. Note that the authentication unit 22 executes authentication processing by using, for example, ActiveDirectory or SSH.

If the authentication unit 22 determines that the authentication has failed (NO in step S2), the medical information management system rejects the login attempt, and the processing is terminated.

In contrast, if the authentication unit 22 determines that the authentication has succeeded (YES in step S2), the medical information management system permits the login attempt by the medical team (each host of the meeting). In this case, the information referred history acquisition unit 23 refers to information referred history information stored in the storage unit 21 and acquires the reference information (URI) contained in the information referred history information in association with the MDT ID received by the authentication unit 22 (that is, the MDT ID in the login information) (step S3). Note that it is possible to acquire reference information from the storage unit 21 by using, for example, SQL as a query language.

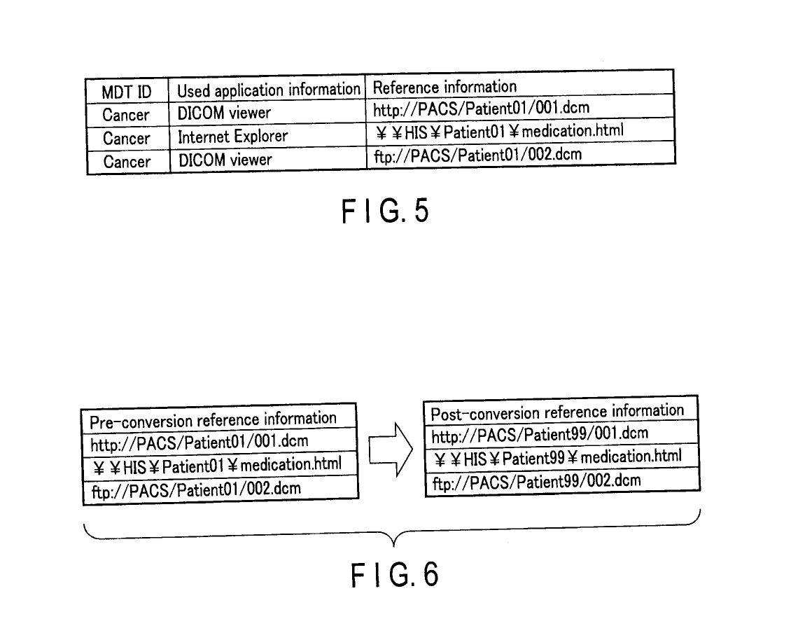

In this case, the information referred history information shown in FIG. 3 described above is stored in the storage unit 21. If the authentication unit 22 receives “Cancer” as an MDT ID, reference information contained in the information referred history information is acquired in association with MDT ID “Cancer”, as shown in FIG. 5.

The information referred history conversion unit 24 then analyzes the URI (character string) acquired by the information referred history acquisition unit 23, and converts the URI into a URI for accessing medical information about the target patient (i.e., the patient under discussion) (step S4).

URI conversion processing by the information referred history conversion unit 24 will be described in detail below. In this case, the information referred history conversion unit 24 acquires patient identification information (to be written as a patient ID hereinafter) for identifying a target patient from, for example, a system (an MDT meeting system or the like) inside or outside a hospital. A patient ID for identifying a target patient will be referred to as a target patient ID hereinafter.

The information referred history conversion unit 24 specifies the patient ID contained in the URI acquired by the information referred history acquisition unit 23. The information referred history conversion unit 24 replaces the specified patient ID (the patient ID contained in the URI acquired by the information referred history acquisition unit 23) with the target patient ID. With this operation, the URI acquired by the information referred history acquisition unit 23 is converted into a URI containing the target patient ID. Assume that the patient ID contained in a URI can be recognized by referring to, for example, the database (DB) included in an external system (PACS, HIS, RIS, nurse record system, or the like).

For the sake of concreteness, assume that reference information “¥¥HIS¥Patient01¥medication.html” shown in FIG. 5 is used. In this case, the reference information (i.e., the URI) contains patient ID “Patient01”. Assuming that the target patient ID is “Patient99”, reference information “¥¥HIS¥Patient01¥medication.html” is converted into reference information “¥¥HIS¥Patient99¥medication.html”. FIG. 6 shows the conversion result of each piece of reference information shown in FIG. 5 when the target patient ID is “Patient99”. Reference information before it is converted by the information referred history conversion unit 24 will be referred to as pre-conversion reference information hereinafter, and reference information after it is converted by the information referred history conversion unit 24 will be referred to as post-conversion reference information hereinafter.

As described above, medical information is saved in each of external systems (PACS, HIS, RIS, nurse record system, and the like), which can communicate with the medical information management server 20, in accordance with a predetermined rule. For this reason, if, for example, medical information accessible based on pre-conversion reference information “http://PACS/Patient01/001.dcm” shown in FIG. 6 is DICOM data (image data) about the patient identified by patient ID “Patient01”, medical information accessible based on post-conversion reference information “http://PACS/Patient99/001.dcm” is DICOM data of the same type as that of the DICOM data accessible based on the pre-conversion reference information and becomes DICOM data about the patient identified by patient ID “Patient99”.

Note that the conversion processing for the reference information described above is an example, and may be changed, as needed, in accordance with, for example, a method of saving medical information in an external system. That is, the reference information acquired by the information referred history acquisition unit 23 may be converted into information with which medical information about a target patient similar to medical information referred to with the reference information can be acquired.

The related information acquisition unit 25 acquires medical information (medical information about the target patient) from the external system based on the reference information (i.e., the post-conversion reference information) converted by the information referred history conversion unit 24 (step S5). In other words, the related information acquisition unit 25 acquires medical information by accessing the external system based on the URI contained in the post-conversion reference information. In this case, the related information acquisition unit 25 acquires medical information by, for example, a communication method (http, Windows® Explorer, or FTP in the example shown in FIG. 6) corresponding to each post-conversion reference information such as HTTP client information or FTP client information.

Note that the related information acquisition unit 25 may acquire all medical information accessible based on post-conversion reference information or may be configured to acquire medical information based on predetermined priorities. More specifically, the related information acquisition unit 25 can be set to acquire medical information which has been frequently referred to or always acquire DICOM data (.dcm file).

The related information transmission unit 26 transmits the medical information acquired by the related information acquisition unit 25 to the client terminal 10 by using, for example, a communication API (Application Programming Interface) (step S6). In this case, the related information transmission unit 26 transmits, to the client terminal 10, the used application information contained in information referred history information in association with the MDT ID received by the authentication unit 22, together with the medical information acquired by the related information acquisition unit 25.

The information transmission/reception unit 11 included in the client terminal 10 receives the medical information and used application information transmitted by the related information transmission unit 26 by using, for example, a communication API.

Based on the used application information received by the information transmission/reception unit 11, the information display unit 12 then activates the application indicated by the used application information, and makes the activated application read the medical information received by the information transmission/reception unit 11. With this operation, the information display unit 12 displays the medical information received by the information transmission/reception unit 11 by using the activated application (step S7). Note that the medical information is displayed in a form that allows all the participants constituting the medical team in the above meeting to recognize the information.

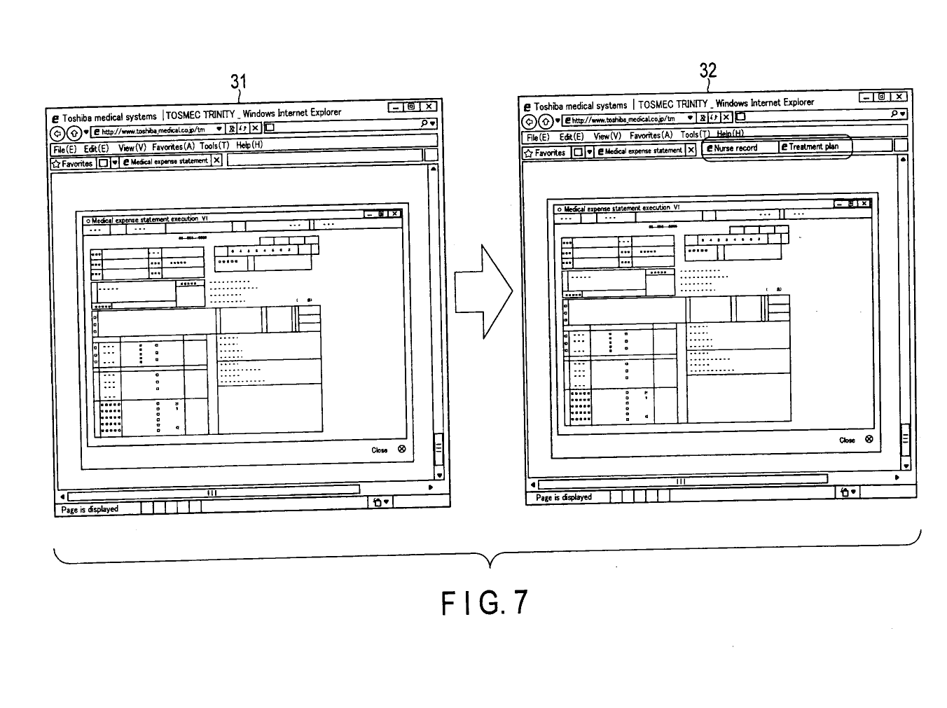

More specifically, if the used application information received by the information transmission/reception unit 11 indicates a browser such as Internet Explorer® or Chrome and the medical information is medical expense statement information, the browser is made to read the medical expense statement information and is activated. In this case, for example, a screen 31 shown in FIG. 7 is displayed.

Furthermore, assume that while a browser is activated in the client terminal 10, the information transmission/reception unit 11 receives used application information indicating the browser and information (medical information) about a nurse record and a treatment plan. In this case, as indicated by a screen 32 shown in FIG. 7, making a tab read the information about the nurse record and the treatment plan can make the screen ready to quickly display also the information about the nurse record and the treatment plan (that is, it is possible to quickly switch the screen).

Although the browser has been mainly described above, it is possible to display medical information by using other applications used in a meeting, such as an image viewer and a PDF reader.

As described above, in this embodiment, the client terminal 10 transmits type information representing the type of medical team who holds a meeting to the medical information management server 20. The medical information management server 20 then acquires reference information for referring to the medical information contained in information referred history information in association with the transmitted type information, and acquires a patient ID for identifying a patient to be discussed in the meeting held by the type of medical team represented by the type information. The medical information management server 20 then acquires medical information about the patient identified by the patient ID based on the reference information. The client terminal 10 displays the acquired medical information. This makes it possible to quickly display the medical information on the client terminal 10 without performing any operation such as inputting search conditions for medical information about the patient in the meeting.

That is, in this embodiment, the client terminal 10 reads in advance, from the medical information management server 20, medical information necessary for discussions in a meeting, which is acquired based on medical information (i.e., referred history information) referred to in a past meeting held by the same type of medical team. This enables the client terminal 10 to quickly display necessary information in the meeting.

Although this embodiment has been described as being applied to a meeting (MDT meeting) in team medical care, the embodiment may be applied to general conferences and the like. In such a case, it is possible to omit the identification information of a medical meeting (such as type information).

That is, this embodiment may be configured to make the medical information management server 20 acquire recommended medical information from medical information about a target patient in the current medical meeting based on the reference information of medical information referred to by participants in a past medical meeting and provide the acquired recommended medical information to each client terminal 10. This arrangement makes it possible to quickly display patient information necessary for a discussion on each terminal.

### Second Embodiment

The second embodiment will be described next. The arrangement of a medical information management system according to this embodiment is the same as that in the first embodiment described above, and hence will be described with reference to FIG. 1, as needed.

The medical information management system according to this embodiment differs from that according to the first embodiment in that the information referred history information stored in a storage unit 21 further includes a display format of medical information (an image display parameter and the like).

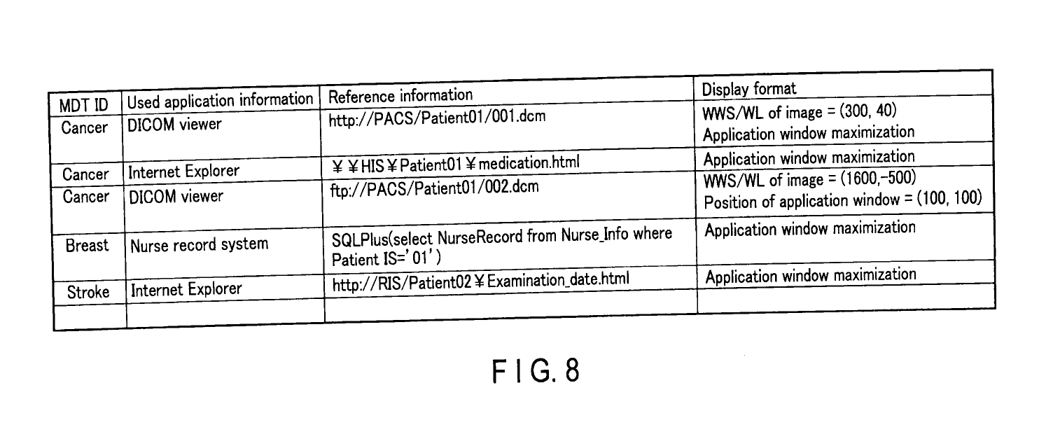

FIG. 8 shows an example of the data structure of information referred history information stored in the storage unit 21 according to this embodiment.

As shown in FIG. 8, information referred history information includes used application information, reference information, and display formats in association with MDT IDs. Each display format is a display format used when medical information which can be referred to by using associated reference information (i.e., medical information accessible based on the URI contained in the reference information) was referred to in a past meeting. Note that if medical information is DICOM data (image data) or the like, the display format contains, for example, a window width (WW), a window level (WL), and the like. Note that the MDT IDs, used application information, and reference information contained in information referred history information are the same as those in the first embodiment described above, and hence a detailed description of them will be omitted.

In the example shown in FIG. 8, the information referred history information contains used application “DICOM viewer”, reference information “http://PACS/patient01/001.dcm”, and display format “WW/WL of image=(300, 40)” and “application window maximization” in association with MDT ID “Cancer”. This information indicates that the type of medical team indicated by MDT ID “Cancer” has set medical information (image data) accessible by using a DICOM viewer using “http://PACS/patient01/001.dcm” to WW/WL=(300, 40), and has referred to (displayed) the window upon maximizing it.

A processing procedure in the medical information management system according to this embodiment will be described next. For the sake of convenience, differences from the first embodiment described above will be mainly described below with reference to the flowchart of FIG. 4 described above.

First of all, the same processing as that in steps S1 to S5 shown in FIG. 4 is executed. Subsequently, when executing the processing in step S6 in FIG. 4, a related information transmission unit 26 transmits the used application information and display format contained in information referred history information to a client terminal 10 in association with the MDT ID received by an authentication unit 22.

An information transmission/reception unit 11 included in the client terminal 10 receives the medical information, used application information, and display format transmitted by the related information transmission unit 26 by using, for example, a communication API.

Subsequently, an information display unit 12 displays the medical information received by the information transmission/reception unit 11 by using the activated application in the same manner as in the processing in step S7 shown in FIG. 4. In this case, the medical information received by the information transmission/reception unit 11 is displayed in the display format received by the information transmission/reception unit 11.

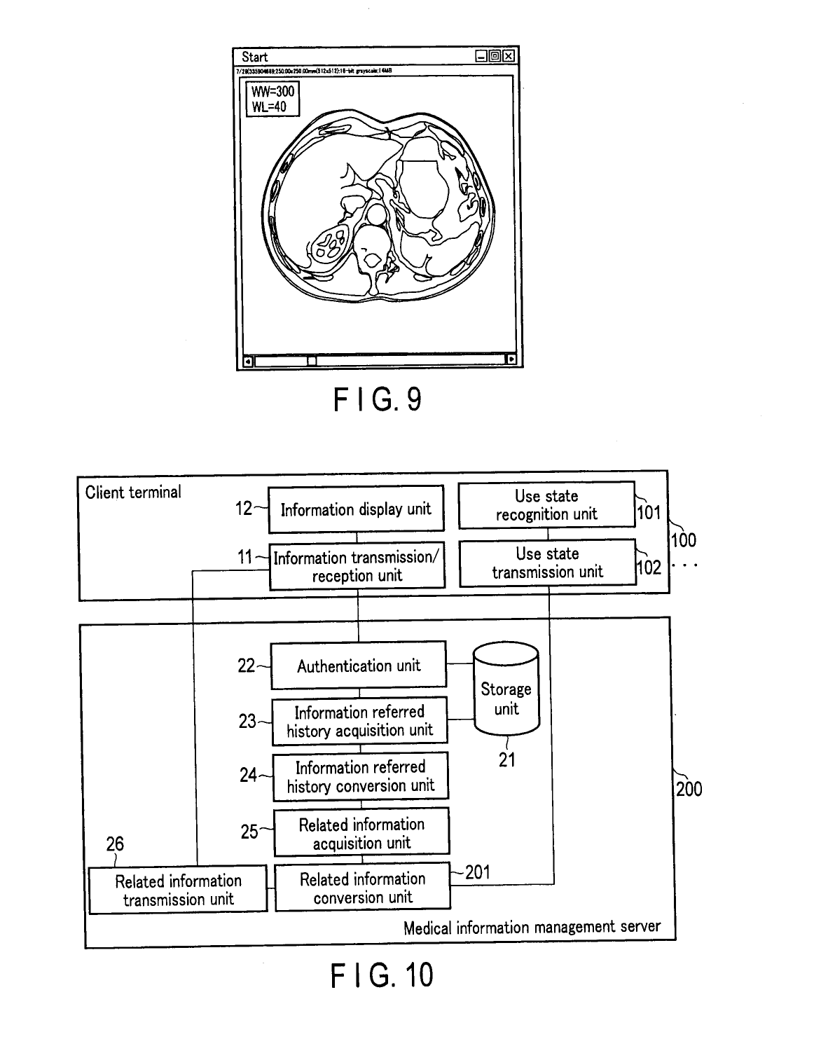

More specifically, assume that the medical information received by the information transmission/reception unit 11 is DICOM data (image data accessible based on http://PACS/Patient01/001.dcm), the used application information indicates a DICOM viewer, and the display format is WW/WL=(300, 40) and the application window maximization. In this case, as shown in FIG. 9, the information display unit 12 respectively sets the window width (WW) and window level (WL) of the image data to 300 and 40, maximizes the window, and displays it by using the DICOM viewer.

As described above, this embodiment is configured to display, on the client terminal 10, the medical information acquired by a related information acquisition unit 25 (the medical information accessible based on the URI converted based on a patient ID for identifying the patient under discussion in a meeting) in the display format contained in information referred history information in association with the MDT ID received by a medical information management server 20. This makes it possible to display medical information about a target patient in the same display format as that of medical information referred to in a past meeting.

### Third Embodiment

The third embodiment will be described next. FIG. 10 is a block diagram mainly showing the functional arrangement of a medical information management system according to this embodiment. Note that the same reference numerals as those in FIG. 1 described above denote the same components, and a detailed description of them will be omitted. Differences from FIG. 1 will be mainly described below.

The medical information management system according to this embodiment differs from that according to the first embodiment described above in that it converts medical information into a format that allows the application used in a client terminal to display the information, and transmits the converted medical information to the client terminal.

As shown in FIG. 10, the medical information management system includes a client terminal 100 and a medical information management server 200 communicably connected to the client terminal 100.

The client terminal 100 includes a use state recognition unit 101 and a use state transmission unit 102. The use state recognition unit 101 recognizes the application used in the client terminal 100.

The use state transmission unit 102 transmits information (to be written as use state information hereinafter) representing the application recognized by the use state recognition unit 101 to the medical information management server 200.

The medical information management server 200 includes a related information conversion unit 201. The related information conversion unit 201 converts the medical information acquired by a related information acquisition unit 25 into a format that can be displayed by the application indicated by the use state information transmitted by the use state transmission unit 102 (that is, the application used in the client terminal 100).

Note that a related information transmission unit 26 transmits the medical information converted by the related information conversion unit 201 in this manner to the client terminal 100. The information is displayed by the application used in the client terminal 100.

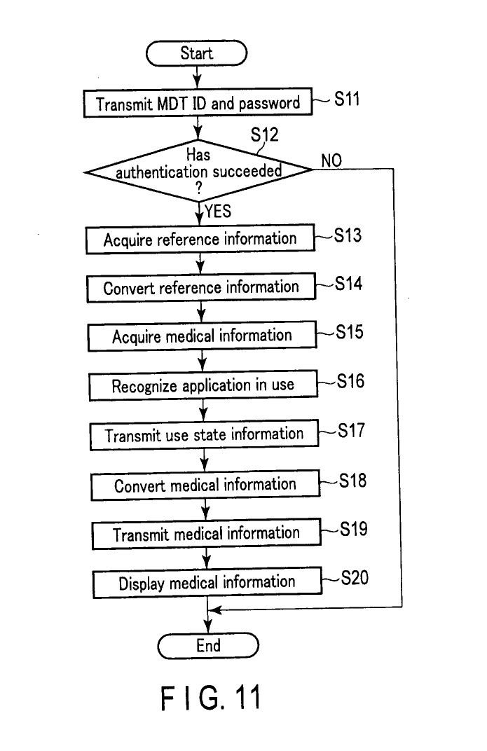

A processing procedure in the medical information management system according to this embodiment will be described next with reference to the flowchart of FIG. 11.

First of all, the processing in steps S11 to S15 which corresponds to the processing in steps S1 to S5 shown in FIG. 4 described above is executed.

The use state recognition unit 101 included in the client terminal 100 recognizes the application currently used by the client terminal 100 (i.e., the application in use) by using, for example, WindowsAPI (step S16). Note that an application in use is discriminated based on whether, for example, a window provided by the application in the client terminal 100 is active.

The use state transmission unit 102 transmits use state information representing the application recognized by the use state recognition unit 101 to the medical information management server 200 by using a communication API or the like (step S17). Note that the use state information transmitted by the use state transmission unit 102 contains, for example, the application name of the application recognized by the use state recognition unit 101 and the version information of the application.

The related information conversion unit 201 included in the medical information management server 200 receives the use state information transmitted by the use state transmission unit 102.

The related information conversion unit 201 converts the medical information acquired by the related information acquisition unit 25 in step S15 into a format that can be displayed by the application used in the client terminal 100 based on the application name, version information, and the like contained in the received use state information (step S18).

More specifically, if DICOM data (image data in the DICOM format) is acquired in step S15 and the use state information received by the related information conversion unit 201 indicates version 9 of InternetExplorer, the related information conversion unit 201 converts the DICOM data into a format (image conversion) that can be displayed by a browser such as JPG or PNG by using, for example, a DICOM library. In this case, the header information and the like of the DICOM data are also converted into the HTML format. This makes it possible to display DICOM data on the browser, which cannot be originally displayed by the browser. According to the above description, DICOM data is converted into JPG or PNG data, and the header information of the DICOM data is converted into the HTML format. However, these pieces of information may be converted into another arbitrary format (e.g., PDF or XML) as long as it can be displayed by the application used in the client terminal 100.

The related information transmission unit 26 transmits the medical information whose format has been converted by the related information conversion unit 201 to the client terminal 100 (step S19).

An information transmission/reception unit 11 included in a client terminal 10 receives the medical information transmitted by the related information transmission unit 26 by using, for example, API.

An information display unit 12 then causes the application used in the client terminal 100 (that is, the application which has already been activated) which can display the medical information to read the medical information received by the information transmission/reception unit 11. With this operation, the information display unit 12 displays the medical information received by the information transmission/reception unit 11.

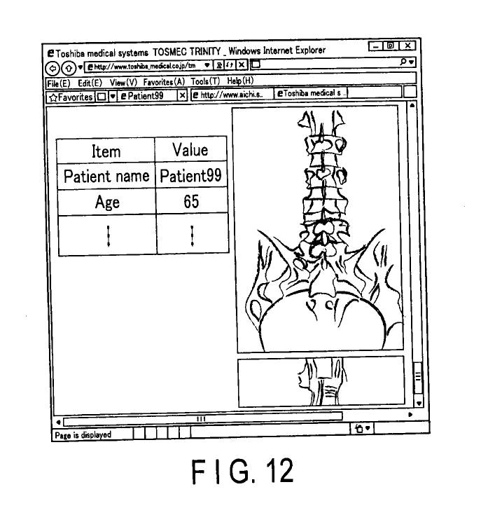

FIG. 12 shows an example of the display screen of the client terminal 100 when the information display unit 12 displays medical information.

The example shown in FIG. 12 indicates a display screen when the browser used in the client terminal 100 displays a plurality of pieces of medical information (image data) converted into, for example, a format which can be displayed by the browser in the medical information management server 200.

Note that in this embodiment, since the medical information transmitted from the medical information management server 200 is converted into a format that can be displayed by a single application (e.g., a browser), adding patient information or the like representing a target patient to the medical information and displaying the resultant information as shown in FIG. 12 makes it possible to simultaneously check the medical information and patient information without switching between applications. Note that patient information may be acquired from, for example, an HIS (Hospital Information System) outside the medical information management system based on, for example, a patient ID for identifying a target patient.

As described above, this embodiment is configured to convert medical information about a target patient into a format that can be displayed by the application used in the client terminal 100 and transmit the information to the client terminal 100. With this arrangement, since it is possible to display (check) all the medical information transmitted from the medical information management server 20 by using a single application, it is not necessary to switch between applications when displaying the medical information. This makes it possible to save the time required to switch between the applications.

### Fourth Embodiment

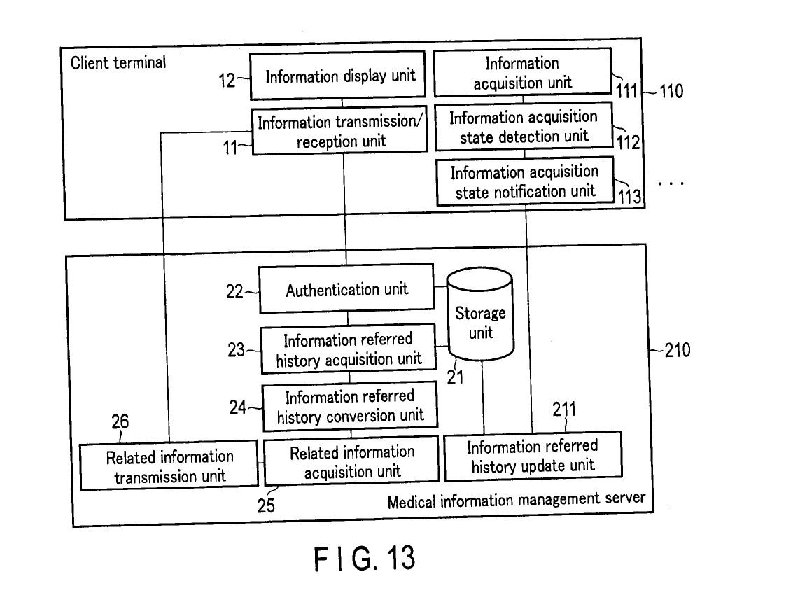

The fourth embodiment will be described next. FIG. 13 is a block diagram mainly showing the functional arrangement of a medical information management system according to this embodiment. Note that the same reference numerals as those in FIG. 1 described above denote the same components, and a detailed description of them will be omitted. Differences from FIG. 1 will be mainly described below.

The medical information management system according to this embodiment differs from that according to the first embodiment described above in that it updates information referred history information every time a meeting for discussing a patient is held.

As shown in FIG. 13, the medical information management system includes a client terminal 110 and a medical information management server 210 communicably connected to the client terminal 110.

The client terminal 110 includes an information acquisition unit 111, an information acquisition state detection unit 112, and an information acquisition state notification unit 113.

The information acquisition unit 111 acquires medical information (third medical information) about a patient under discussion in a meeting from an external system. Note that, for example, an information display unit 12 displays the medical information acquired by the information acquisition unit 111.

The information acquisition state detection unit 112 detects a URI representing the acquisition destination of the medical information acquired by the information acquisition unit 111 and an application to be used to display the medical information.

The information acquisition state notification unit 113 notifies the medical information management server 210 of the URI and application detected by the information acquisition state detection unit 112.

The medical information management server 210 includes an information referred history update unit 211. The information referred history update unit 211 updates the information referred history information stored in a storage unit 21 based on the notification from the information acquisition state notification unit 113. The operation of the medical information management system according to this embodiment will be described below. The medical information management system according to the embodiment executes information referred history update processing in addition to the processing described in the first embodiment (the processing shown in FIG. 4).

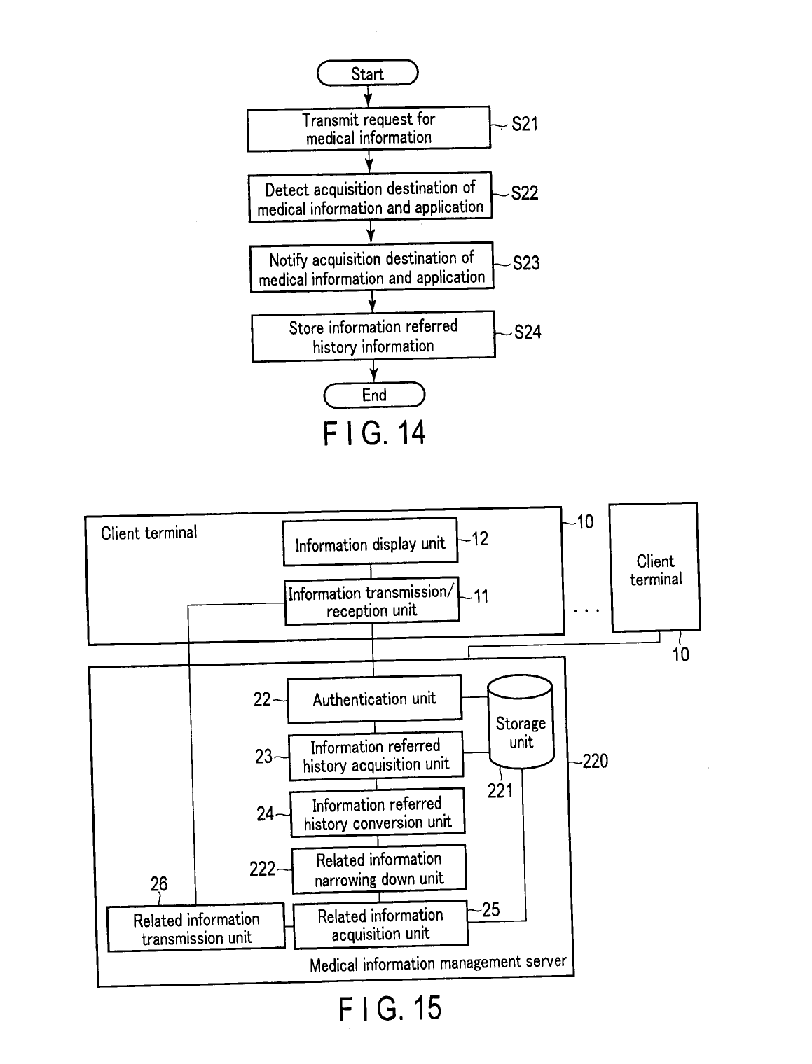

A processing procedure for information referred history update processing executed by the medical information management system according to this embodiment will be described with reference to the flowchart shown in FIG. 14.

First of all, for example, during a meeting, the information acquisition unit 111 included in the client terminal 110 can transmit a request for medical information (medical information about a patient under discussion in the meeting) to an external system by using a protocol such as HTTP or FTP (step S21). Medical information as a request target from the information acquisition unit 111 will be referred to as target medical information hereinafter.

The external system to which this request has been transmitted transmits target medical information to the client terminal 110. This enables the information acquisition unit 111 to acquire the target medical information from the external system. For example, the information display unit 12 displays the target medical information acquired by the information acquisition unit 111. This information is then referred to in a meeting.

As described above, when the information acquisition unit 111 transmits a request, the information acquisition state detection unit 112 detects a URI representing the acquisition destination of target medical information and an application to be used to display the target medical information (an application in use) (step S22).

The information acquisition state notification unit 113 notifies the medical information management server 210 of the URI and application detected by the information acquisition state detection unit 112 by using a communication API or the like (step S23).

The information referred history update unit 211 included in the medical information management server 210 newly stores, in the storage unit 21, information referred history information including reference information containing the URI notified from the information acquisition state notification unit 113 and the application information representing an application in association with the MDT ID in the login information (that is, the MDT ID received by an authentication unit 22) (step S24).

Information referred history update processing will be specifically described below. When, for example, the client terminal 110 has transmitted a request for target medical information (DICOM data) to a PACS as an external system, the medical information management server 210 is notified of, for example, “http://PACS/Patient99/001.dcm” as a URI which is the acquisition destination of target medical information and “DICOM viewer” as an application to be used for displaying the target medical information. In this case, if, for example, the MDT ID in the login information is “Cancer”, the storage unit 21 stores information referred history information containing reference information “http://PACS/Patient99/001.dcm” and used application information “DICOM viewer” in association with MDT ID “Cancer”.

As described above, since this embodiment is configured to update the information referred history information stored in the storage unit 21 every time medical information is acquired from an external system in a meeting, it is possible to transmit necessary medical information without omission from the medical information management server 210 to the client terminal 110 in a meeting as compared with a case in which the information referred history information stored in the storage unit 21 is not updated.

### Fifth Embodiment

The fifth embodiment will be described next. FIG. 15 is a block diagram mainly showing the functional arrangement of a medical information management system according to this embodiment. Note that the same reference numerals as those in FIG. 1 described above denote the same components, and a detailed description of them will be omitted. Differences from FIG. 1 will be mainly described below.

The medical information management system according to this embodiment differs from that according to the first embodiment described above in that a client terminal 120 displays medical information in consideration of the roles (professions) of participants constituting a medical team (i.e., participants in a meeting) who holds a meeting.

As shown in FIG. 15, the medical information management system includes a client terminal 10 and a medical information management server 220 communicably connected to the client terminal 10.

The medical information management server 220 includes a storage unit 221 and a related information narrowing down unit 222. The storage unit 221 stores role-related information in addition to login information and information referred history information described in the first embodiment. The role-related information stored in the storage unit 221 is information indicating, for each of the roles of the participants constituting a medical team who holds a meeting, medical information (acquisition destinations thereof) related to each role.

The related information narrowing down unit 222 acquires the role information of each participant constituting a medical team who holds a meeting from a system outside the medical information management system. The related information narrowing down unit 222 narrows down the reference information (URIs) converted by an information referred history conversion unit 24 based on the acquired role information of a participant and the role-related information stored in the storage unit 221.

Note that a related information acquisition unit 25 according to this embodiment acquires medical information from an external system based on the reference information narrowed down by the related information narrowing down unit 222. The related information narrowing down unit 222 and the related information acquisition unit 25 in this embodiment correspond to the recommended information acquisition device when acquiring recommended medical information in accordance with the role information of each participant in the current medical meeting.

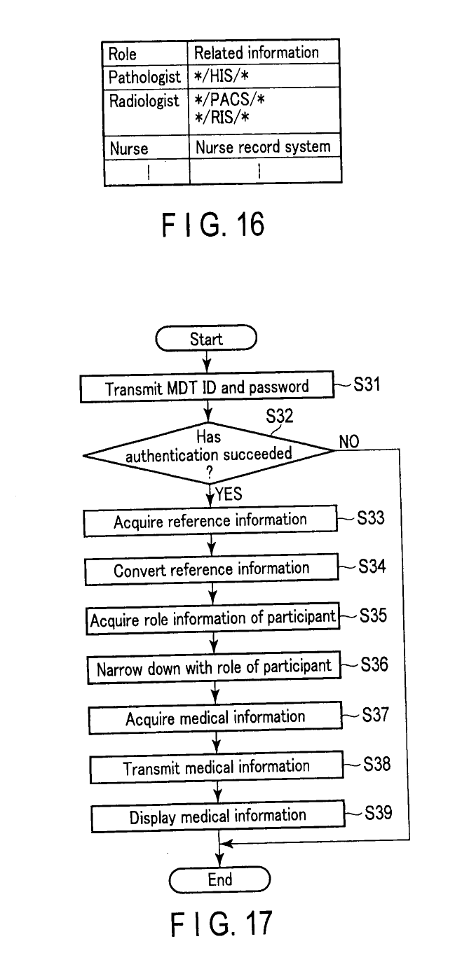

FIG. 16 shows an example of the data structure of role-related information stored in the storage unit 221 shown in FIG. 15.

As shown FIG. 16, role-related information contains related information in association with each role. Roles indicate, for example, the professions of participants constituting a medical team who holds a meeting. Related information indicates the acquisition destination of medical information related to an associated role (that is, an external system which saves medical information related to the role).

In the example shown in FIG. 16, role-related information contains related information “*/HIS/*” in association with role “pathologist”. This indicates that medical information related to the participant whose profession is “pathologist” among the participants constituting the medical team who holds a meeting is saved in an HIS (Hospital Information System).

Assume that role-related information is prepared in advance concerning the roles (professions) of all the participants constituting a medical team who holds meeting.

In addition, the related information shown in FIG. 16 is an example, and the method of expressing the related information can be changed in accordance with each system.

A processing procedure in the medical information management system according to this embodiment will be described next with reference to the flowchart of FIG. 17.

First of all, the processing in steps S31 to S34 which corresponds to the processing in steps S1 to S4 shown in FIG. 4 is executed.

The related information narrowing down unit 222 included in the medical information management server 220 acquires the role information of a participant in the medical team who holds the meeting (step S35). In this case, the role information of each participant in the medical team who holds the meeting is acquired from an external system such as a system which manages information about the meeting (for example, an MDT meeting system), conference system, or a scheduling system.

The related information narrowing down unit 222 narrows down the reference information converted by the information referred history conversion unit 24 in step S34 based on the acquired role information of each participant and the role-related information stored in the storage unit 221 (step S36).

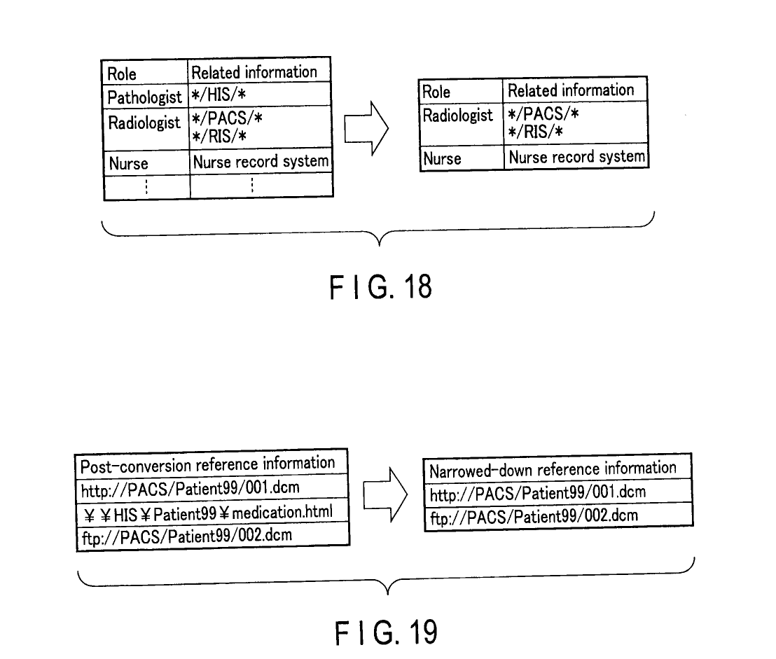

The processing in step S36 will be specifically described below. In this case, the related information narrowing down unit 222 acquires related information contained in role-related information in association with each piece of acquired role information of the participants. More specifically, if the role-related information shown in FIG. 16 is stored in the storage unit 221 and the pieces of the role information (profession information) of the participants acquired by the related information narrowing down unit 222 are “radiologist” and “nurse”, the related information narrowing down unit 222 acquires pieces of related information “*/PACS/*”, “*/RIS/*”, and “nurse record system”, as shown FIG. 18.

The related information narrowing down unit 222 narrows down the reference information converted by the information referred history conversion unit 24 to reference information containing URIs indicating the storage positions of medical information acquired from the external systems indicated by the acquired related information.

In this case, “*” contained in the above related information represents an arbitrary character string. If, therefore, the related information acquired by the related information narrowing down unit 222 is, for example, “*/PACS/*”, the reference information converted by the information referred history conversion unit 24 is narrowed down to a URI (reference information) containing “/PACS/”. The same applies to the other information.

More specifically, as shown in FIG. 19, assume that the pieces of reference information converted by the information referred history conversion unit 24 are three pieces of information, namely, “http://PACS/Patient99/001.dcm”, “¥¥HIS¥Patient99¥medication.html”, and “ftp://PACS/Patient99/002.dcm”, and the pieces of related information acquired by the related information narrowing down unit 222 are “*/PACS/*”, “*/RIS/*”, and “nurse record system”. In this case, the three pieces of post-conversion reference information are narrowed down to two pieces of information, namely, “http://PACS/Patient99/001.dcm” and “ftp://PACS/Patient99/002.dcm”. In this case, these pieces of information are narrowed down to URIs represented by “*/PACS/*” (i.e., URIs with PACS as an acquisition destination).

Referring to FIG. 19, the reference information converted by the information referred history conversion unit 24 is written as post-conversion reference information, and the reference information narrowed down by the related information narrowing down unit 222 is written as narrowed-down reference information.

Referring back to FIG. 17, the related information acquisition unit 25 acquires medical information (medical information related to a target patient) from an external system based on the reference information narrowed down (narrowed-down reference information) by the related information narrowing down unit 222 (step S37). With this operation, the related information acquisition unit 25 can acquire medical information related to the role of a participant in the medical team who holds a meeting.

Subsequently, the processing in steps S38 and S39 corresponding to the processing in steps S6 and S7 shown in FIG. 4 is executed.

As described above, this embodiment is configured to narrow down medical information to medical information related to the role of a participant in a medical team who holds a meeting and transmit the information to the client terminal 10. This makes it possible to display, on the client terminal 10, only medical information useful for the participant (that is, medical information related to the participant in the meeting).

According to the above description, in this embodiment, role-related information is stored in the storage unit 221 in advance. However, role-related information may be statistically calculated (generated) from, for example, information referred history information and the like. More specifically, if, for example, many pieces of medical information saved in an HIS (Hospital Information System) have been referred to in a meeting held by a medical team constituted by a participant whose role is “pathologist” and the like, role-related information containing related information “*/HIS/*” in association with role “pathologist” may be generated and stored in the storage unit 221.

### Sixth Embodiment

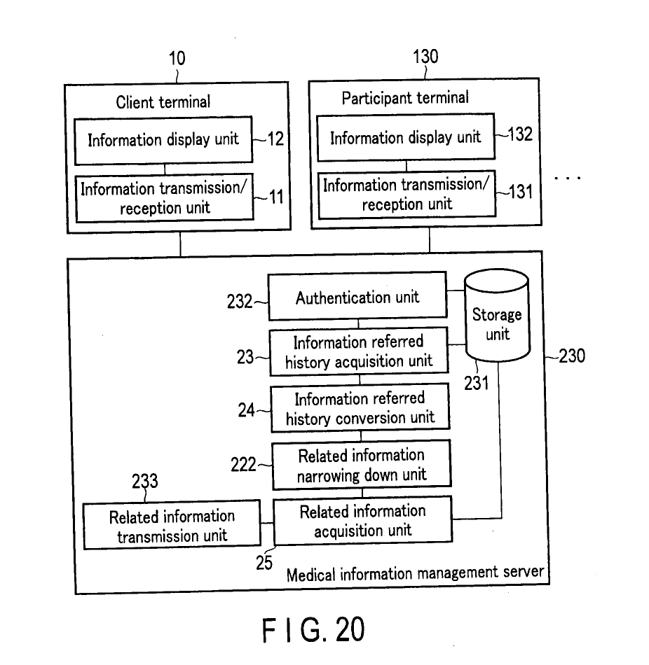

The sixth embodiment will be described next. FIG. 20 is a block diagram mainly showing the functional arrangement of a medical information management system according to this embodiment. Note that the same reference numerals as those in FIGS. 1 and 15 described above denote the same components, and a detailed description of them will be omitted. Differences from FIGS. 1 and 15 will be mainly described below.

The medical information management system according to this embodiment differs from that according to the fifth embodiment in that medical information related to the role of each participant constituting a medical team who holds a meeting is displayed on the participant terminal held by each participant.

As shown in FIG. 20, the medical information management system includes a client terminal (main client terminal) 10, a participant terminal (sub-client terminal) 130, and a medical information management server 230. The medical information management server 230 is communicably connected to the client terminal 10 and the participant terminal 130. Although each participant constituting a medical team who holds a meeting holds the participant terminal 130, FIG. 20 shows only the single participant terminal 130 for the sake of convenience.

The participant terminal 130 includes an information transmission/reception unit 131 and an information display unit 132. The information transmission/reception unit 131 is a functional unit for transmitting/receiving various types of information to/from the medical information management server 230.

More specifically, the information transmission/reception unit 131 transmits, to the medical information management server 230, an individual ID for identifying a participant holding the participant terminal 130 (that is, a participant constituting a medical team who holds a meeting) and a password corresponding to the individual ID. The information transmission/reception unit 131 also receives medical information about a patient under discussion in a meeting from the medical information management server 230.

The information display unit 132 is a functional unit for displaying various types of information. More specifically, the information display unit 132 displays the medical information received by the information transmission/reception unit 131 to the participant holding the participant terminal 130.

The medical information management server 230 includes a storage unit 231, an authentication unit 232, and a related information transmission unit 233.

The storage unit 231 further stores individual login information in addition to the above login information and information referred history information. Individual login information is information used when the participant holding the participant terminal 130 logs in from the participant terminal 130 to the medical information management system. Note that individual login information contains an individual ID for identifying each participant holding the participant terminal 130 and a password determined in advance with respect to the individual ID in association with each other for each participant. In addition, individual login information may contain the above type information (MDT ID), individual ID, and password in association with each other for each participant.

The authentication unit 232 receives the individual ID and password transmitted by the information transmission/reception unit 131 included in the participant terminal 130. The authentication unit 232 performs authentication based on the received individual ID and password and the individual login information stored in the storage unit 231.

The related information transmission unit 233 transmits the medical information acquired by a related information acquisition unit 25 to the client terminal 10. In addition, the related information transmission unit 233 transmits, to the participant terminal 130 held by a participant constituting a medical team who holds a meeting, medical information, of the medical information acquired by the related information acquisition unit 25, which is related to the role of the participant.

The operation of the medical information management system according to this embodiment will be described next. The medical information management system according to the embodiment executes processing for a client terminal and processing for a participant terminal. Note that the processing for the client terminal is the same as that shown in FIG. 17 described above, and hence a detailed description of it will be omitted.

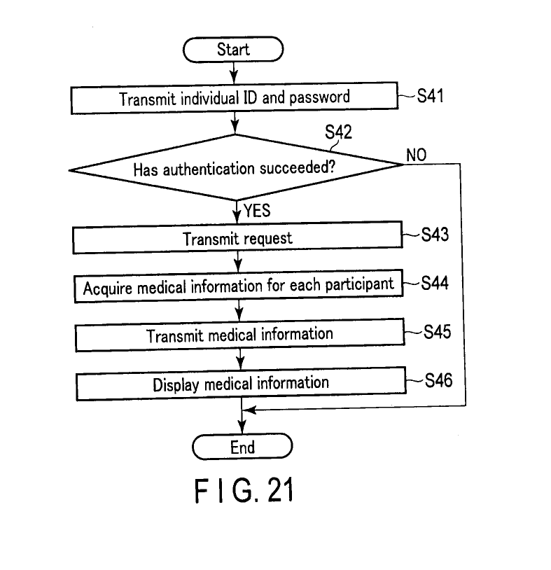

A processing procedure for processing for a participant terminal which is executed by the medical information management system according to this embodiment will be described with reference to the flowchart of FIG. 21. Note that processing for a participant terminal is performed after a host of a meeting logs in from the client terminal 10 to the medical information management system.

First of all, the participant holding the participant terminal 130 needs to log in to the medical information management system.

In this case, the participant holding the participant terminal 130 inputs an individual ID for identifying the participant and a password by operating the participant terminal 130.

When the participant holding the participant terminal 130 inputs an individual ID and a password in this manner, the information transmission/reception unit 131 included in the participant terminal 130 transmits the input individual ID and password to the medical information management server 230 (step S41).

The authentication unit 232 included in the medical information management server 230 receives the individual ID and password transmitted by the participant terminal 130 (the information transmission/reception unit 131 included in it).

The authentication unit 232 executes authentication processing based on the received individual ID and password and the individual login information stored in the storage unit 231, and determines the success or failure of the authentication (step S42). If the received individual ID and password are associated with the individual login information, the authentication unit 232 determines that the authentication has succeeded. If received individual ID and password are not associated with the individual login information, the authentication unit 232 determines that the authentication has failed.

If the authentication unit 232 determines that the authentication has failed (NO in step S42), the medical information management system rejects the login attempt, and the processing is terminated.

In contrast, if the authentication unit 232 determines that the authentication has succeeded (YES in step S42), the medical information management system permits the login attempt by the participant holding the participant terminal 130. In this case, for example, the host of the meeting can transmit, via the client terminal 10, a request for the transmission of medical information to the participant terminal 130 held by the participant who has logged in to the medical information management system (step S43).

When the client terminal 10 has transmitted a request, the medical information management server 230 acquires medical information related to each participant who has logged in to the medical information management system (step S44). Although a detailed description will be omitted, medical information related to each participant who has logged in to the medical information management system is acquired by executing the same processing as that in steps S33 to S37 shown in FIG. 17 described above.

The related information transmission unit 233 transmits the acquired medical information related to each participant who has logged in to the medical information management system to the participant terminal 130 held by the participant (step S45). That is, the medical information related to the participant is transmitted to the participant terminal 130 held by the participant. If, for example, the role-related information shown in FIG. 16 is stored in the storage unit 231, the medical information acquired from the hospital information system indicated by related information “*/HIS/*” (that is, medical information accessible based on the URI represented by “*/HIS/*”) is transmitted to the participant terminal 130 held by the participant whose role (profession) is “pathologist”.

Note that a related information transmission unit 26 transmits, together with medical information, the used application information contained in information referred history information in association with the MDT ID received by the authentication unit 232 when a host of a meeting logs in.

The information transmission/reception unit 131 included in the participant terminal 130 receives the medical information and used application information transmitted by the related information transmission unit 233.

The information display unit 132 displays the medical information based on the medical information and used application information received by the information transmission/reception unit 131. Note that the specific processing to be performed when displaying medical information is the same as that in the first embodiment described above, and hence a detailed description of it will be omitted.

That is, according to the above participant terminal processing, the participant terminal 130 held by each participant displays medical information related to the participant. In contrast to this, according to client terminal processing, as described in the fifth embodiment, the client terminal 10 displays medical information related to the roles of all the participants constituting a medical team who holds a meeting.

As described above, this embodiment is configured to display medical information related to the role of a participant on the participant terminal 130 held by the participant. This enables the participant to easily check the medical information related to himself/herself regardless of the display on the client terminals 10 which all the participants check.

According to the above description, in this embodiment, the medical information management server 230 transmits medical information related to a participant to the participant terminal 130 held by the participant in accordance with a request from the client terminal 10. However, the embodiment may be configured to transmit the medical information in accordance with a request from the participant terminal 130 or automatically transmit the medical information without any request from the client terminal 10 and the participant terminal 130.

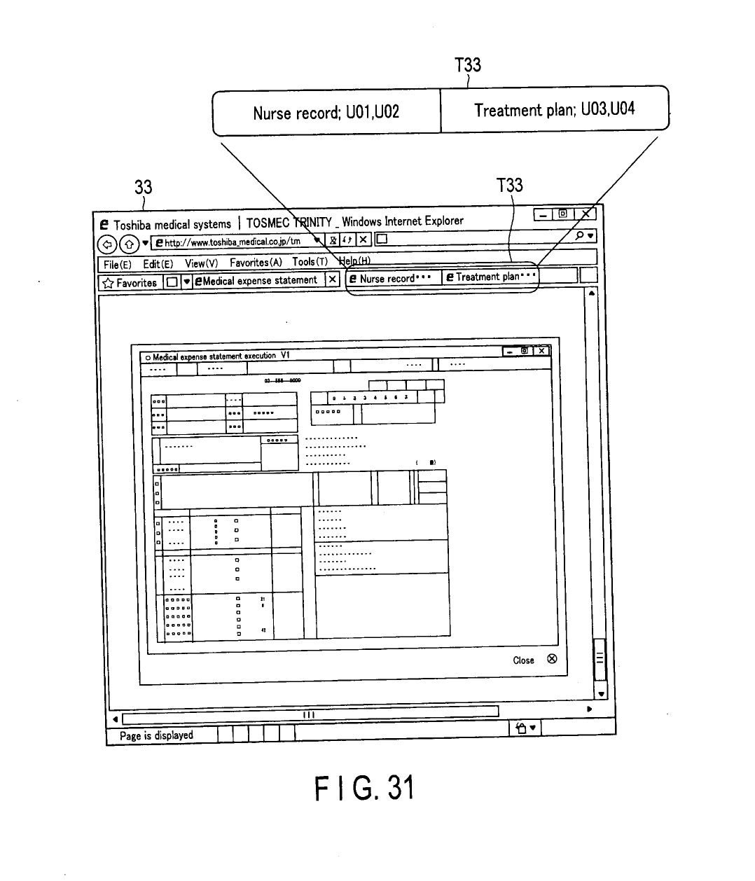

In addition, in this embodiment, for example, as indicated by a screen 33 shown in FIG. 31, a tab T33 may be made to read in advance nurse records, information about treatment plans, and individual IDs “U01”, “U02”, . . . of participants corresponding to the participant terminals 130 which are displaying the information. In this case, the tab T33 including the individual IDs of the participants can make information visually recognized by each participant ready for quick display (that is, can quickly switch the display).

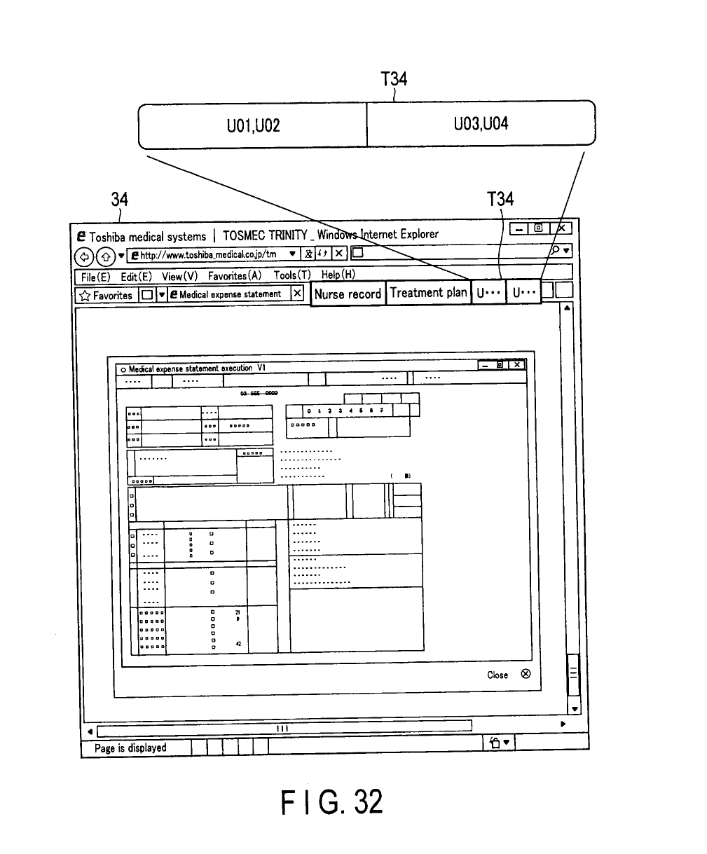

Furthermore, in this embodiment, for example, as indicated by a screen 34 shown in FIG. 32, a tag T34 may be made to read in advance individual IDs “U01”, “U02”, . . . of participants corresponding to the display screen of the participant terminal 130. In this case, likewise, it is possible to make the information visually recognized by each participant ready for quick display (that is, can quickly switch the display).

### Seventh Embodiment

The seventh embodiment will be described next. The arrangement of a medical information management system according to this embodiment is the same as that according to the first embodiment, and hence will be described, as needed, with reference to FIG. 1.

The medical information management system according to this embodiment differs from that according to the first embodiment in that it further acquires medical information based on patient information about a patient (target patient) under discussion in a meeting.

In the medical information management system according to this embodiment, a storage unit 21 included in a medical information management server 20 further stores patient history information in addition to login information and information referred history information.

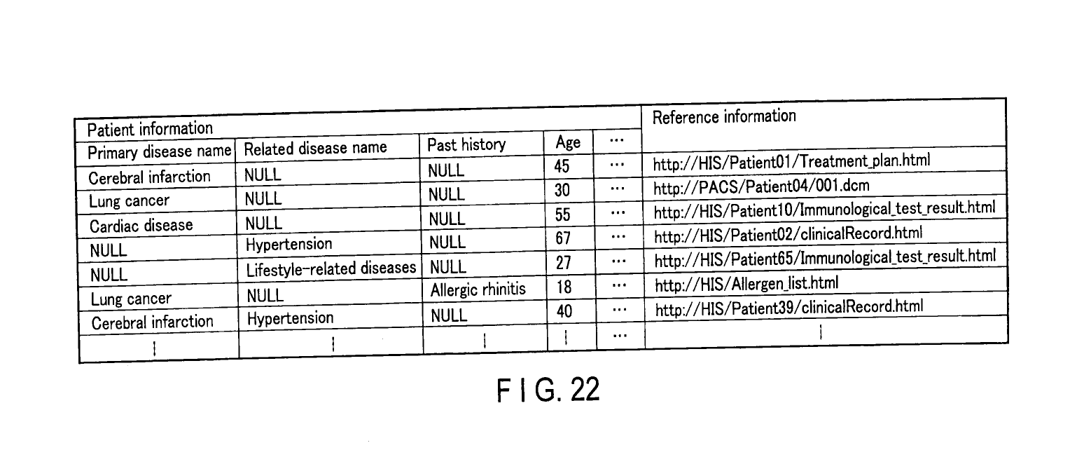

In this case, FIG. 22 shows an example of the data structure of the patient history information stored in the storage unit 21 in this embodiment.

As shown in FIG. 22, patient history information contains patient information and reference information in association with each other. Patient information is information representing a patient, and contains the name of the primary disease from which the patient is suffering, related disease name, the past history and age of the patient, and the like. Reference information is information for referring to medical information referred to in a past meeting for discussing the patient indicated by the associated patient information (that is, information for accessing the medical information). More specifically, this information contains a URI indicating the storage position of the medical information (i.e., the acquisition destination of the medical information) in an external system saving the medical information.

In the example shown in FIG. 22, the patient history information contains patient information including, for example, primary disease name “cerebral infarction” and age “45” and reference information “http://HIS/Patient01/treatment_plan.html” in association with each other. This information indicates that medical information accessible based on “http://HIS/Patient01/treatment_plan.html” was referred to in a past meeting for discussing a patient whose primary disease name is cerebral infarction and age is 45.

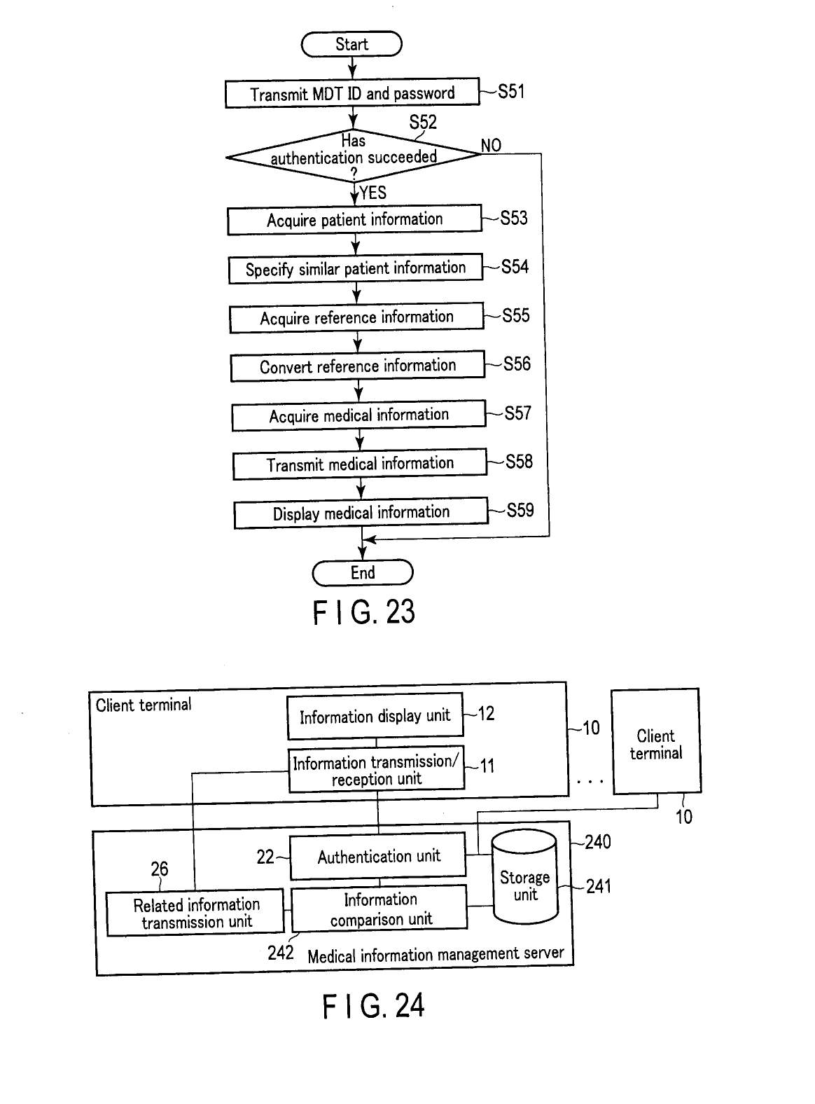

A processing procedure in the medical information management system according to this embodiment will be described next with reference to the flowchart of FIG. 23.

First of all, the processing in steps S51 and S52 which corresponds to the processing in steps S1 and S2 shown in FIG. 4 is executed.

An information referred history acquisition unit 23 then acquires patient information representing a target patient (a patient to be discussed in a meeting) (step S53). This patient information is acquired from, for example, an HIS (Hospital Information System) outside the medical information management system based on a patient ID and the like. Note that the patient information acquired by the information referred history acquisition unit 23 contains a primary disease name, related disease name, past history, age, and the like. The patient information acquired by the information referred history acquisition unit 23 will be referred to as target patient information hereinafter.

The information referred history acquisition unit 23 specifies patient information, of the patient information contained in the patient history information stored in the storage unit 21, which is similar to the target patient information (step S54).

In this case, the information referred history acquisition unit 23 compares, for example, the target patient information with the patient information contained in the patient history information, and counts the number of matching items between the target patient information and the patient information, thereby calculating the correlation value between the target patient information and the patient information. With this operation, it is possible to specify, for example, patient information whose correlation value with respect to the target patient information is a predetermined value or more as patient information similar to the target patient information. Note that the above processing for specifying patient information similar to target patient information is an example, and hence it is possible to perform other types of processing to specify patient information similar to target patient information.

The information referred history acquisition unit 23 acquires reference information from the information referred history information and patient history information stored in the storage unit 21 (step S55). More specifically, the information referred history acquisition unit 23 acquires the reference information contained in the information referred history information in association with the MDT ID received by the authentication unit 22. In addition, the information referred history acquisition unit 23 acquires the reference information contained in the patient history information in association with the above specified patient information.

Subsequently, the processing in step S56 which corresponds to the processing in step S4 shown in FIG. 4 is executed with respect to the reference information acquired by the information referred history acquisition unit 23 (the reference information contained in the information referred history information and the reference information contained in the patient history information). The processing in steps S57 to S59 which corresponds to the processing in steps S5 to S7 shown in FIG. 4 is then executed.

As described above, in this embodiment, the client terminal 10 further displays medical information about a target patient acquired based on the reference information contained in patient history information in association with patient information similar to the target patient information. This makes it possible to display necessary medical information on the client terminal 10 without omission in a meeting as compared with the first embodiment described above.

### Eighth Embodiment

The eighth embodiment will be described next. FIG. 24 is a block diagram mainly showing the functional arrangement of a medical information management system according to this embodiment. Note that the same reference numerals as those in FIG. 1 described above denote the same components, and a detailed description of them will be omitted. Differences from FIG. 1 will be mainly described below.

The medical information management system according to this embodiment differs from that according to the first embodiment in that a client terminal displays differences between medical information about a patient (target patient) under discussion in a meeting and past medical information.

As shown in FIG. 24, the medical information management system includes a client terminal 10 and a medical information management server 240 communicably connected to the client terminal 10.

The medical information management server 240 includes a storage unit 241 and an information comparison unit 242.

The storage unit 241 further stores difference management information in addition to the login information described in the first embodiment. The difference management information stored in the storage unit 241 contains a difference information path for acquiring difference information representing a difference between medical information referred to in a meeting and medical information older than the medical information (medical information accessed before the meeting).

In this case, the client terminal 10 can transmit a request for medical information about a patient under discussion in a meeting to the medical information management server 240. Note that the request transmitted by the client terminal 10 contains a URI indicating the storage position (acquisition destination) of medical information for which the request has been issued.

When the client terminal 10 transmits a request, based on the URI contained in the request, the MDT ID received by an authentication unit 22, and the difference management information stored in the storage unit 241, the information comparison unit 242 acquires difference information concerning medical information accessible based on the URI.

The information comparison unit 242 acquires medical information from an external system based on the URI contained in the request transmitted by the client terminal 10.

The information comparison unit 242 compares the acquired difference information with the medical information to generate difference information representing the difference between the difference information and the medical information.

The information comparison unit 242 executes difference enhancement processing for the medical information acquired from an external system based on the generated difference information.

A related information transmission unit 26 transmits the medical information having undergone difference enhancement processing by the information comparison unit 242 to the client terminal 10. An information transmission/reception unit 11 included in the client terminal 10 receives the medical information transmitted by the related information transmission unit 26. An information display unit 12 displays the information.

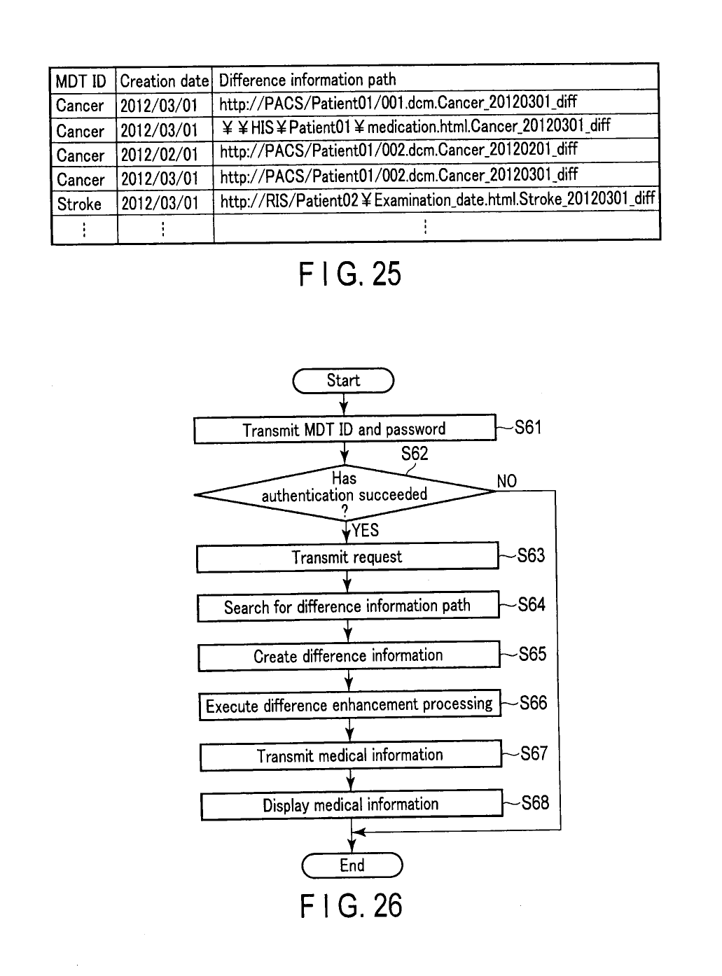

FIG. 25 shows an example of the data structure of the difference management information stored in the storage unit 241 shown in FIG. 24.

As shown in FIG. 25, difference management information contains MDT IDs, creation dates and times, and difference information paths in association with each other. A creation date indicates a date when difference information is created. A difference information path is information, in a meeting held by the type of medical team indicated by an associated MDT ID, which is used to refer to (acquire) difference information (a file in which the difference is written) indicating the difference between medical information referred to at the associated creation date and medical information accessed before the meeting. The difference information path contains, for example, a URI indicating the storage position (acquisition destination) of the difference information. Note that since an MDT ID is the same as that described in the first embodiment, a detailed description of it will be omitted.

In the example shown in FIG. 25, the difference management information contains, for example, MDT ID “Cancer”, creation date “2012/03/01”, and difference information path “http://PACS/Patient01/001.dcm.Cancer_{—}20120301_diff”. This information indicates that difference information representing the difference between medical information referred to in a meeting held by the type of medical team (a medical team on cancer) indicated by MDT ID “Cancer” on Mar. 1, 2012 and medical information accessed before Mar. 1, 2012 is stored at the storage position indicated by “http://PACS/Patient01/001.dcm.Cancer_{—}20120301_diff”. Note that the above difference management information is updated every time a meeting is held (that is, every time medical information is referred to in the meeting).

A processing procedure in the medical information management system according to this embodiment will be described next with reference to the flowchart of FIG. 26.

First of all, the processing in steps S61 and S62 which corresponds to the processing in steps S1 and S2 shown in FIG. 4 is executed.

In this case, for example, a host of a meeting can transmit a request for medical information about a patient under discussion in the meeting via the client terminal 10 (step S63). This request contains a URI for acquiring medical information as a target for the request. Note that the request for medical information is transmitted to the medical information management server 240 via a browser, file system, or the like.

The information comparison unit 242 receives the request transmitted by the client terminal 10. The information comparison unit 242 refers to the URI contained in the received request and the difference management information stored in the storage unit 241, and searches for the difference information path contained in the difference management information in association with the MDT ID received by the authentication unit 22 (step S64). In this case, the information comparison unit 242 searches for the difference information path which is contained in the difference management information in association with the MDT ID received by the authentication unit 22 and contains the URI contained in the received request. Note that if a plurality of difference information paths are searched out, the information comparison unit 242 acquires the difference information path corresponding to the latest creation date contained in the difference management information in association with the difference information path.

More specifically, assume that the MDT ID received by the authentication unit 22 is “Cancer”, the difference management information shown in FIG. 25 described above is stored in the storage unit 241, and the URI contained in the request received by the information comparison unit 242 is “http://PACS/Patient01/002.dcm”. In this case, the information comparison unit 242 acquires difference information path “http://PACS/Patient01/002.dcm.Cancer_{—}20120301_diff”.

The information comparison unit 242 then acquires difference information based on the acquired difference information path. In addition, the information comparison unit 242 acquires medical information from an external system based on the URI contained in the received request.

The information comparison unit 242 compares the acquired difference information and the medical information, and finds the difference between the difference information and the medical information for each character string by character string processing or in binary. With this operation, the information comparison unit 242 generates difference information (step S65).

The difference information generated by the information comparison unit 242 is saved in the same folder as that of the difference information acquired by the information comparison unit 242, with the file name being generated by adding the MDT ID received by the authentication unit 22 and the date when the difference information was created (creation date) to the end of the URI contained in the request received by the information comparison unit 242.

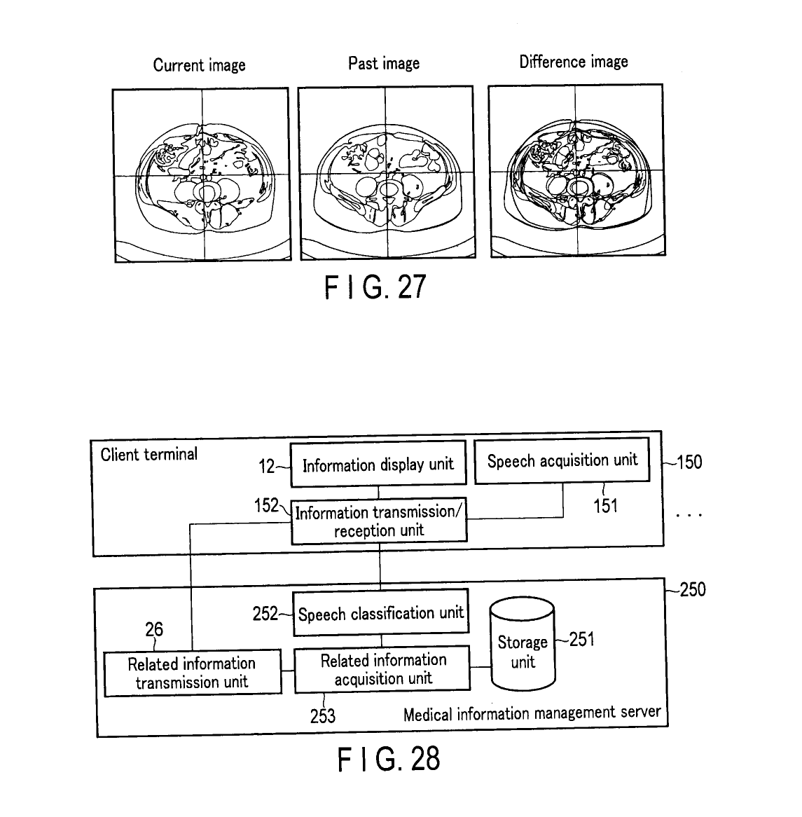

The information comparison unit 242 then executes difference enhancement processing for the acquired medical information (i.e., the medical information requested by the client terminal 10) based on the generated difference information (step S66). In this case, the information comparison unit 242 performs enhancement display processing for character strings and images contained in both the medical information and the difference information. More specifically, if the medical information is an HTML file, the information comparison unit 242 adds a “Bold” tag, a color change tag, and the like as HTML tags. If the medical information is an image, the information comparison unit 242 performs the processing of generating a difference image by changing the pixel values of pixels exhibiting pixel value differences or adding an annotation and adding the difference image to the original image. When performing difference enhancement processing for an image, as shown in FIG. 27, it is preferable to provide an image which allows easy comparison between the current and past images (medical information) by performing, for example, registration (aligning the images with each other) of a difference image expressing density value differences in color (an image having undergone difference enhancement processing), as needed.

The related information transmission unit 26 transmits the medical information for which the difference enhancement processing has been executed by the information comparison unit 242 to the client terminal 10 (step S67).

In addition, the medical information transmitted by the related information transmission unit 26 is displayed by an application such as a browser used in the client terminal 10 (step S68).

As described above, this embodiment is configured to perform difference enhancement processing based on difference information representing the difference between the medical information (current medical information) requested by the client terminal 10 during a meeting and the medical information (past medical information) accessed in the past and display the medical information having undergone the difference enhancement processing on the client terminal 10. This arrangement makes it possible to easily grasp the difference between the current medical information in the meeting and the past medical information.

Note that if, for example, medical information is an examination result including a heart rate, the difference information between the current medical information and the past medical information may contain numerical values and the like representing differences between the current examination result and the past examination result. Enhancing numerical values contained in such difference information on the client terminal 10 makes it possible to easily recognize, for example, a change in the numerical value of the heart rate of a target patient in a meeting.

In addition, according to the above description, in this embodiment, the processing in and after step S64 shown in FIG. 26 is executed for the URI contained in the request transmitted by the client terminal 10. However, the processing in and after step S64 shown in FIG. 26 may be executed for, for example, the URI contained in the reference information converted by the information referred history conversion unit 24 (post-conversion reference information) in the first embodiment described above.

### Ninth Embodiment

The ninth embodiment will be described next. FIG. 28 is a block diagram mainly showing the functional arrangement of a medical information management system according to this embodiment. Note that the same reference numerals as those in FIG. 1 described above denote the same components, and a detailed description of them will be omitted. Differences from FIG. 1 will be mainly described below.

The medical information management system according to this embodiment differs from that according to the first embodiment in that it discriminates the contents of a discussion from the contents of statements from participants in a meeting and displays medical information related to the contents of the discussion on each client terminal.

As shown in FIG. 28, the medical information management system includes a client terminal 150 and a medical information management server 250 communicably connected to the client terminal 150.

The client terminal 150 includes a speech acquisition unit 151 and an information transmission/reception unit 152. The speech acquisition unit 151 acquires speech from participants in a meeting for discussing a patient.

The information transmission/reception unit 152 transmits the information of speech (to be written as the speech information hereinafter) acquired by the speech acquisition unit 151 to the medical information management server 250. An information transmission/reception unit 11 receives medical information related to a patient under discussion in a meeting from a medical information management server 20.

The medical information management server 250 includes a storage unit 251, a speech classification unit 252, and a related information acquisition unit 253.

The storage unit 251 stores in advance category-specific related information representing the acquisition destinations of medical information related to categories representing the contents of discussions in a meeting.

The speech classification unit 252 receives the speech information transmitted by the information transmission/reception unit 152 included in the client terminal 150. The speech classification unit 252 executes speech recognition processing for the acquired speech information. The speech classification unit 252 decides a category representing the contents of a discussion in a meeting based on the speech recognition processing result. The speech classification unit 252 forms a device configured to acquire conversation information in a medical meeting. In this example, “conversation information” corresponds to “a category representing the contents of a discussion”.

The related information acquisition unit 253 acquires a patient ID for identifying a patient under discussion in a meeting. Based on the category-specific related information stored in the storage unit 251, the category decided by the speech classification unit 252, and the acquired patient ID, the related information acquisition unit 253 acquires medical information which is related to the category and is related to the patient identified by the patient ID from an external system. The related information acquisition unit 253 corresponds to a recommended information acquisition device configured to acquire recommended medical information in accordance with conversion information.

A related information transmission unit 26 transmits the medical information acquired by the related information acquisition unit 253 to the client terminal 150. The information transmission/reception unit 152 included in the client terminal 150 receives the medical information transmitted by the related information transmission unit 26. The information display unit 12 displays the received information.

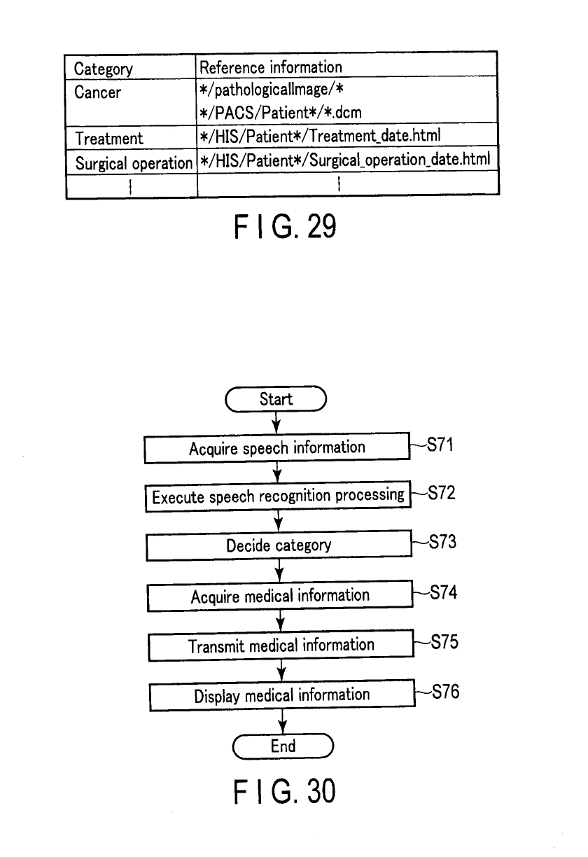

FIG. 29 shows an example of the data structure of the category-specific related information stored in the storage unit 251 shown in FIG. 28.

As shown in FIG. 29, the category-specific related information contains reference information in association with each category. Each category represents the contents of a discussion in a meeting. Reference information is information for referring to medical information related to the associated category (the contents of the discussion) (that is, information for accessing the medical information), and represents, for example, a URI as the acquisition destination of the medical information.

In the example shown in FIG. 29, the category-specific related information contains, for example, reference information “*/pathologicalImage/*” and “*/PACS/Patient*/*.dcm” in association with category “Cancer”. This information indicates that medical information related to cancer can be acquired based on the URIs represented by “*/pathologicalImage/*” and “*/PACS/Patient*/*.dcm”. Note that “*” contained in reference information contained in category-specific related information represents an arbitrary character string.

A processing procedure in the medical information management system according to this embodiment will be described next with reference to the flowchart of FIG. 30.

First of all, the speech acquisition unit 151 included in the client terminal 150 acquires an utterance (speech information) from a participant in a meeting by using a sound collector such as a microphone (step S71). The speech information collected (acquired) by the speech acquisition unit 151 is transmitted to the medical information management server 250.

The speech classification unit 252 included in the medical information management server 250 receives the speech information transmitted by the client terminal 150 (the information transmission/reception unit 152 included in it).

The speech classification unit 252 executes speech recognition processing for the received speech information (step S72). More specifically, the speech classification unit 252 categorizes the speech information by using, for example, a statistical speech recognition technique using a language model or a speech recognition technique using a hidden Markov model or rule based method.

The speech classification unit 252 decides the category of the received speech information (the category representing the contents of the discussion in the meeting) based on such a speech recognition processing result (step S73).

The related information acquisition unit 253 acquires a patient ID (target patient ID) related to the patient under discussion (target patient) in the meeting. Note that the target patient ID is acquired from, for example, a system inside or outside the hospital (an MDT meeting system or the like).

The related information acquisition unit 253 acquires medical information based on the category-specific related information stored in the storage unit 251, the category decided by the speech classification unit 252, and the target patient ID (step S74).

Acquisition processing for medical information by the related information acquisition unit 253 will be specifically described below. In this case, the related information acquisition unit 253 refers to the category-specific related information stored in the storage unit 251 to acquire the reference information contained in the category-specific related information in association with the category decided by the speech classification unit 252.

The related information acquisition unit 253 then converts a portion, of the URI represented by the acquired reference information, which corresponds to the patient ID based on the target patient ID. More specifically, assume that the reference information acquired by the related information acquisition unit 253 is “*/PACS/Patient*/*.dcm” shown in FIG. 29 and the target patient ID is “Patient99”. In this case, the related information acquisition unit 253 converts “*/PACS/Patient*/*.dcm” into “*/PACS/Patient99/*.dcm”.

The related information acquisition unit 253 acquires medical information from an external system based on the converted reference information. If the reference information is converted into “*/PACS/Patient99/*.dcm” as described above, the related information acquisition unit 253 acquires medical information accessible based on a URI containing an arbitrary character string in the portion of “*” of “*/PACS/Patient99/*.dcm”.

With this operation, the related information acquisition unit 253 can acquire medical information which is related to the contents of the discussion in the meeting and is related to the target patient.

The related information transmission unit 26 transmits the medical information acquired by the related information acquisition unit 253 to the client terminal 150 (step S75).

The information display unit 12 included in the client terminal 150 displays the medical information transmitted by the related information transmission unit 26 by using an application used in the client terminal 150 or an application which can display the medical information (step S76).

Note that periodically executing the processing shown in FIG. 30 can display proper medical information on the client terminal 150, even if the subject (the contents of the discussion) changes during a meeting, in accordance with the change in the contents of the discussion.

As described above, this embodiment is configured to display the medical information acquired based on speech from participants during a meeting on the client terminal 150, and hence it is possible to quickly display medical information corresponding to the contents of a discussion in the meeting.

According to the embodiment described above, it is possible to provide a medical information management apparatus which can quickly display information about a patient on a terminal.

Although several embodiments have been described above, they are merely examples and not intended to limit the scope of the present invention. These embodiments can be implemented in other various forms, and various omissions, replacements, and changes can be made without departing from the spirit of the present invention. These embodiments and their modifications are incorporated in the scope and sprit of the present invention, and are also incorporated in the scope of the invention and its equivalents defined in the appended claims.

Medical information management systems in the embodiments in Japanese Patent Application No. 2012-259596 as the basic application of the present application are appended below.

[1]: A medical information management system according to an embodiment comprises a client terminal and a medical information management server communicably connected to the client terminal. The client terminal includes a transmission device and a display device. The medical information management server includes a storage device, a first acquisition device, a second acquisition device, and a third acquisition device. The storage device is configured to store in advance information referred history information containing reference information for referring to first medical information related to a patient referred to in a past meeting for discussing the patient in association with type information representing a type of medical team constituted by a plurality of participants who held the meeting. The transmission device is configured to transmit type information representing a type of medical team who holds a meeting for discussing a patient to the medical information management server. The first acquisition device is configured to acquire reference information for referring to the first medical information contained in the information referred history information in association with the transmitted type information. The second acquisition device is configured to acquire patient identification information for identifying a patient to be discussed in a meeting held by the type of medical team represented by the transmitted type information. The third acquisition device is configured to acquire second medical information related to a patient identified by patient identification information acquired by the second acquisition device based on reference information for referring to the first medical information acquired by the first acquisition device. The display device is configured to display the second medical information acquired by the third acquisition device.

[2]: In the medical information management system described in [1], the medical information management server further includes a reference information conversion device. Reference information for referring to the first medical information contained in the information referred history information stored in the storage device contains a URI indicating a storage position of the first medical information in an external system which saves the first medical information. The reference information conversion device is configured to convert the URI contained in the reference information for referring to the first medical information acquired by the first acquisition device, based on the patient identification information acquired by the second acquisition device. The third acquisition device acquires the second medical information from the external system based on the converted URI.

[3]: In the medical information system described in [1], the information referred history information stored in the storage device further includes a display format of the first medical information in association with the type information. The first acquisition device further acquires a display format of the first medical information contained in the information referred history information in association with the received type information. The display device displays the second medical information acquired by the second acquisition device in a display format of the first medical information acquired by the first acquisition device.

[4]: In the medical information management system described in [1], the client terminal further includes a recognition device. The recognition device is configured to recognize an application used in the client terminal. The medical information management server further includes a medical information conversion device. The medical information conversion device is configured to convert the second medical information acquired by the third acquisition device into a format that can be displayed by the recognized application. The display device displays the converted second medical information.

[5]: In the medical information management system described in [1], the client terminal further includes a notification device. The notification device is configured to notify the medical information management server that the client terminal has received the third medical information from an external system. The medical information management server further includes an information referred history update device. The information referred history update device is configured to store, in the storage device, information referred history information containing reference information for referring to the third medical information in association with the received type information, based on the notification.

[6]: In the medical information management system described in [1], the medical information management server further includes a fourth acquisition device. The fourth acquisition device is configured to acquire the role information of a participant constituting the type of medical team represented by the received type information. The third acquisition device acquires second medical information which is related to a patient identified by the patient identification information acquired by the second acquisition device and is related to the role information of the participant acquired by the fourth acquisition device, based on reference information for referring to the first medical information acquired by the first acquisition device.

[7]: The medical information management system described in [1] further comprises a participant terminal held by a participant constituting a type of medical team represented by the received type information. The medical information management server further includes a fourth acquisition device. The fourth acquisition device is configured to acquire the role information of a participant constituting the type of medical team represented by the received type information. The third acquisition device acquires second medical information which is related to a patient identified by the patient identification information acquired by the second acquisition device and is related to the role information of the participant acquired by the fourth acquisition device, based on reference information for referring to the first medical information acquired by the first acquisition device. The participant terminal includes a display unit. The display unit displays the second medical information, of the second medical information acquired by the third acquisition device, which is related to the role of the participant holding the participant terminal.

[8]: In the medical information management system described in [1], the storage device further stores patient history information. The patient history information contains reference information for referring to third medical information related to a patient in a past meeting for discussing the patient in association with the first patient information representing the patient. The medical information management server further includes a fourth acquisition device. The fourth acquisition device is configured to acquire the second patient information representing the patient identified by the patient identification information acquired by the second acquisition device. The first acquisition device further acquires reference information for referring to the third medical information contained in the patient history information in association with the first patient information similar to the second patient information acquired by the fourth acquisition device. The third acquisition device further acquires fourth medical information related to the patient identified by the patient identification information acquired by the second acquisition device, based on reference information for referring to the third medical information acquired by the first acquisition device. The display device further displays the fourth medical information acquired by the third acquisition device.

[9]: In the medical information management system described in [1], the medical information management server further includes a fourth acquisition device, a generation device, and a difference enhancement processing device. The fourth acquisition device acquires third medical information which is older than the second medical information acquired by the third acquisition device and is related to the patient identified by the patient identification information acquired by the second acquisition device. The generation device is configured to generate difference information representing a difference between the second medical information acquired by the third acquisition device and the third medical information acquired by the fourth acquisition device. The difference enhancement processing device is configured to execute difference enhancement processing for the second medical information acquired by the third acquisition device based on the generated difference information. The display device displays the second medical information having undergone the difference enhancement processing.

[10]: A medical information management system comprises a client terminal and a medical information management server communicably connected to the client terminal. The client terminal includes a speech acquisition device and a display device. The medical information management server includes a speech classification device, an identification information acquisition device, and a related information acquisition device. The speech acquisition device is configured to acquire speech from participants in a meeting for discussing a patient. The speech classification device is configured to execute speech recognition processing for the speech acquired by the speech acquisition device, and to decide a category representing the contents of the meeting based on the speech recognition processing result. The related information acquisition device acquires medical information which is related to the decided category and is related to the patient under discussion in the meeting. The display device is configured to displays the medical information acquired by the related information acquisition device.

1. A medical information management apparatus communicably connected to a plurality of client terminals, comprising:
a reference information storage device configured to store reference information for medical information referred to by a participant in a past medical meeting;
a recommended information acquisition device configured to acquire recommended medical information from medical information of a target patient in a current medical meeting based on the reference information; and
a providing device configured to provide the acquired recommended medical information to each of the client terminals.

2. The medical information management apparatus of claim 1, wherein the recommended information acquisition device acquires the recommended medical information in accordance with role information of a participant in the current medical meeting.

3. The medical information management apparatus of claim 2, wherein the providing device changes the acquired recommended medical information in accordance with role information of an owner of the client terminal and provides the changed recommended medical information to the client terminal.

4. The medical information management apparatus of claim 1, wherein the recommended information acquisition device acquires a type of the recommended medical information based on reference information for medical information referred to in the same type of medical meeting held in the past, and acquires the recommended medical information in accordance with the acquired type.

5. The medical information management apparatus of claim 1, further comprising a device configured to acquire conversation information in the medical meeting,
wherein the recommended acquisition device acquires the recommended medical information in accordance with the conversation information.

6. The medical information management apparatus of claim 1, wherein the providing device provides medical information about the target patient which is generated in and after a previous medical meeting.

7. The medical information management apparatus of claim 1, wherein the recommended information acquisition device acquires medical information about the target patient from another apparatus via a network.

8. The medical information management apparatus of claim 1, further comprising a medical information storage device configured to acquire medical information about the target patient from another apparatus via a network and storing the information.

9. The medical information management apparatus of claim 1, wherein the reference information storage device stores reference information for medical information referred to by the plurality of client terminals during the medical meeting.

10. The medical information management apparatus of claim 1, wherein the reference information contains identification information of the referred medical information and is stored in the reference information storage device in association with identification information of the medical meeting and identification information of a participant in the medical meeting.
